(19) United States
(12) Patent Application Publication
(10) Pub. No.: US 2023/0314763 A1
(43) Pub. Date: Oct. 5, 2023

(54) PROJECTION SYSTEM AND PROJECTOR

(71) Applicant: SEIKO EPSON CORPORATION, Tokyo (JP)

(72) Inventors: Hitoshi HIRANO, Suwa-shi (JP); Hirotaka YANAGISAWA, Azumino-shi (JP); Akihisa KAGEYAMA, Matsumoto-shi (JP)

(73) Assignee: SEIKO EPSON CORPORATION, Tokyo (JP)

(21) Appl. No.: 18/191,920

(22) Filed: Mar. 29, 2023

(30) Foreign Application Priority Data
Mar. 30, 2022 (JP) 2022-054796

(51) Int. Cl. G02B 9/06; G02B 13/16

(52) U.S. Cl. CPC G02B 9/06; G02B 13/16

(57) ABSTRACT

A projection system includes a first lens group having refractive power, an aperture stop, and a second lens group having refractive power sequentially arranged from the enlargement side toward the reduction side. The first lens group includes a first lens disposed at a position closest to the enlargement side, a second lens disposed at the reduction side of the first lens, and a plurality of positive lenses disposed at the reduction side of the second lens and each having positive power. The portion at the reduction side of a reduction-side lens that forms the second lens group and is located at a position closest to the reduction side is a telecentric portion. The projection system satisfies Conditional Expressions (1) and (2) below,

LnθgF≥0.6 (1)

ω>40° (2)

The present application is based on, and claims priority from JP Application Serial Number 2022-054796, filed Mar. 30, 2022, the disclosure of which is hereby incorporated by reference herein in its entirety.

### BACKGROUND

### 1. Technical Field

The present disclosure relates to a projection system and a projector.

### 2. Related Art

JP-A-2006-330241 describes a projector including a projection system having a half angle of view greater than 40°. The projection system described in JP-A-2006-330241 includes a first lens group having negative power and a second lens group having positive power sequentially arranged from the enlargement side toward the reduction side.

The first lens group is formed of two meniscus lenses each having a convex surface facing the enlargement side. The meniscus lenses each have negative power. The second lens group includes a positive lens, an aperture stop, a negative plastic lens, a negative glass lens, two cemented doublets, and a positive lens arranged from the enlargement side toward the reduction side. In the projection system described in JP-A-2006-330241, the negative plastic lens and the negative glass lens are disposed in succession at the reduction side of the aperture stop to correct a chromatic aberration of magnification.

The projection system described in JP-A-2006-330241 includes the positive lens at the enlargement side of the aperture stop. When the maximum half angle of view of the projection system is greater than 40°, the positive lens is likely to produce a chromatic aberration of magnification. Therefore, to correct the chromatic aberration of magnification produced by the projection system, the chromatic aberration of magnification generated by the positive lens located at the enlargement side of the aperture stop needs to be suppressed.

### SUMMARY

To solve the problem described above, a projection system according to an aspect of the present disclosure includes a first lens group having refractive power, an aperture stop, and a second lens group having refractive power sequentially arranged from an enlargement side toward a reduction side. The first lens group includes a first lens disposed at a position closest to the enlargement side, a second lens disposed at the reduction side of the first lens, and a plurality of positive lenses disposed at the reduction side of the second lens and each having positive power. A portion at the reduction side of a reduction-side lens that forms the second lens group and is located at a position closest to the reduction side is a telecentric portion. The projection system satisfies Conditional Expressions (1) and (2) below,

LnθgF≥0.6 (1)

ω>40° (2)

where LnθgF represents a partial dispersion ratio of one of the first and second lenses, and ω represents a maximum half angle of view of the overall projection system.

A projector according to another aspect of the present disclosure includes the projection system described above and an image formation device that forms a projection image in the reduction-side conjugate plane of the projection system.

### BRIEF DESCRIPTION OF THE DRAWINGS

FIG. 1 shows a schematic configuration of a projector including a projection system according to an embodiment of the present disclosure.

FIG. 2 is a beam diagram showing beams passing through the projection system.

FIG. 3 is a beam diagram showing beams passing through the projection system according to Example 1.

FIG. 4 shows a longitudinal aberration, astigmatism, and distortion in Example 1.

FIG. 5 is a beam diagram showing beams passing through the projection system according to Example 2.

FIG. 6 shows the longitudinal aberration, astigmatism, and distortion in Example 2.

FIG. 7 is a beam diagram showing beams passing through the projection system according to Example 3.

FIG. 8 shows the longitudinal aberration, astigmatism, and distortion in Example 3.

FIG. 9 is a beam diagram showing beams passing through the projection system according to Example 4.

FIG. 10 shows the longitudinal aberration, astigmatism, and distortion in Example 4.

FIG. 11 is a beam diagram showing beams passing through the projection system according to Example 5.

FIG. 12 shows the longitudinal aberration, astigmatism, and distortion in Example 5.

FIG. 13 is a beam diagram showing beams passing through the projection system according to Example 6.

FIG. 14 shows the longitudinal aberration, astigmatism, and distortion in Example 6.

FIG. 15 is a beam diagram showing beams passing through the projection system according to Example 7.

FIG. 16 shows the longitudinal aberration, astigmatism, and distortion in Example 7.

### DESCRIPTION OF EXEMPLARY EMBODIMENTS

An optical system and a projector according to an embodiment of the present disclosure will be described below with reference to the drawings.

### Projector

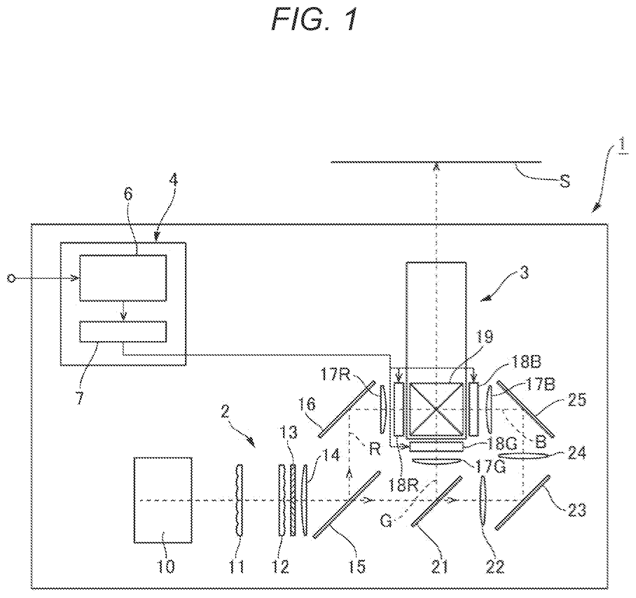

FIG. 1 shows a schematic configuration of a projector including a projection system 3 according to the embodiment of the present disclosure. A projector 1 includes an image formation unit 2, which generates a projection image to be projected onto a screen S, the projection system 3, which enlarges the projection image and projects the enlarged projection image onto the screen S, and a controller 4, which controls the operation of the image formation unit 2, as shown in FIG. 1.

### Image Formation Unit and Controller

The image formation unit 2 includes a light source 10, a first optical integration lens 11, a second optical integration lens 12, a polarization converter 13, and a superimposing lens 14. The light source 10 is formed, for example, of an ultrahigh-pressure mercury lamp or a solid-state light source. The first optical integration lens 11 and the second optical integration lens 12 each include a plurality of lens elements arranged in an array. The first optical integration lens 11 divides a luminous flux from the light source 10 into a plurality of luminous fluxes. The lens elements of the first optical integration lens 11 bring the luminous flux from the light source 10 into focus in the vicinity of the lens elements of the second optical integration lens 12.

The polarization converter 13 converts the light via the second optical integration lens 12 into predetermined linearly polarized light. The superimposing lens 14 superimposes images of the lens elements of the first optical integration lens 11 on one another in a display region of each of liquid crystal panels 18R, 18G, and 18B, which will be described later, via the second optical integration lens 12.

The image formation unit 2 further includes a first dichroic mirror 15, a reflection mirror 16, a field lens 17R, and the liquid crystal panel 18R. The first dichroic mirror 15 reflects R light, which is part of the beam incident via the superimposing lens 14, and transmits G light and B light, which are part of the beam incident via the superimposing lens 14. The R light reflected off the first dichroic mirror 15 travels via the reflection mirror 16 and the field lens 17R and is incident on the liquid crystal panel 18R. The liquid crystal panel 18R is an image formation device. The liquid crystal panel 18R modulates the R light in accordance with an image signal to form a red projection image.

The image formation unit 2 further includes a second dichroic mirror 21, a field lens 17G, and the liquid crystal panel 18G. The second dichroic mirror 21 reflects the G light, which is part of the beam via the first dichroic mirror 15, and transmits the B light, which is part of the beam via the first dichroic mirror 15. The G light reflected off the second dichroic mirror 21 passes through the field lens 17G and is incident on the liquid crystal panel 18G. The liquid crystal panel 18G is an image formation device. The liquid crystal panel 18G modulates the G light in accordance with an image signal to form a green projection image.

The image formation unit 2 further includes a relay lens 22, a reflection mirror 23, a relay lens 24, a reflection mirror 25, a field lens 17B, the liquid crystal panel 18B, and a cross dichroic prism 19. The B light having passed through the second dichroic mirror 21 travels via the relay lens 22, the reflection mirror 23, the relay lens 24, the reflection mirror 25, and the field lens 17B and is incident on the liquid crystal panel 18B. The liquid crystal panel 18B is an image formation device. The liquid crystal panel 18B modulates the B light in accordance with an image signal to form a blue projection image.

The liquid crystal panels 18R, 18G, and 18B surround a cross dichroic prism 19 in such a way that the liquid crystal panels 18R, 18G, and 18B face three sides of the cross dichroic prism 19. The cross dichroic prism 19, which is a prism for light combination, produces a projection image that is the combination of the light modulated by the liquid crystal panel 18R, the light modulated by the liquid crystal panel 18G, and the light modulated by the liquid crystal panel 18B.

The projection system 3 enlarges the combined projection image from the cross dichroic prism 19 and projects the enlarged projection image onto the screen S.

The controller 4 includes an image processor 6, to which an external image signal, such as a video signal, is inputted, and a display driver 7, which drives the liquid crystal panels 18R, 18G, and 18B based on image signals outputted from the image processor 6.

The image processor 6 converts the image signal inputted from an external apparatus into image signals each containing grayscales and other factors of the corresponding color. The display driver 7 operates the liquid crystal panels 18R, 18G, and 18B based on the color projection image signals outputted from the image processor 6. The image processor 6 thus causes the liquid crystal panels 18R, 18G, and 18B to display projection images corresponding to the image signals.

### Projection System

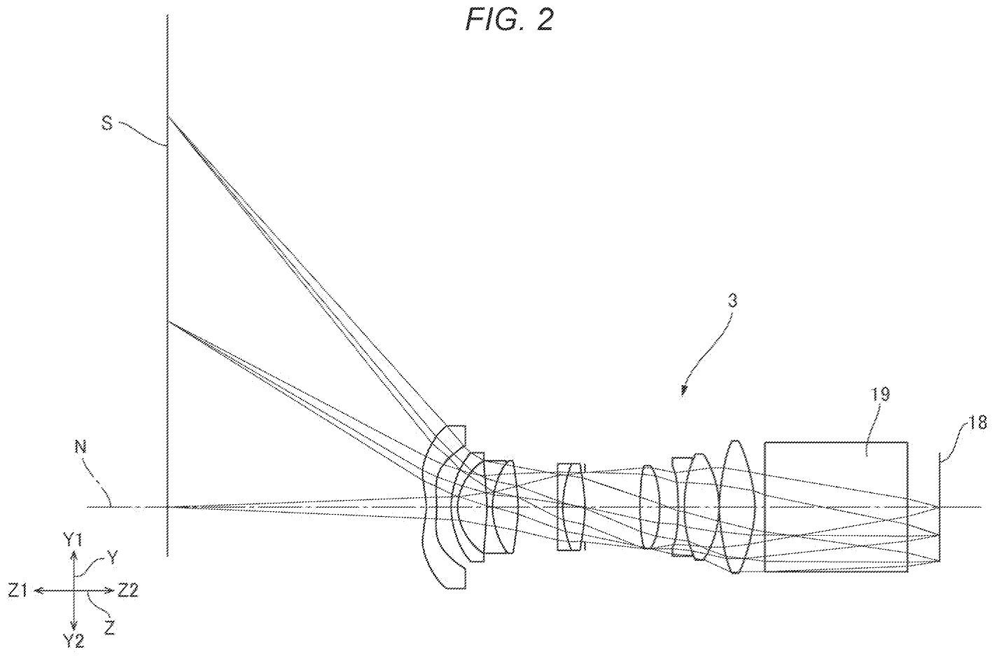

The projection system 3 will next be described. FIG. 2 is a beam diagram showing beams passing through the projection system 3. In FIG. 2, the liquid crystal panels 18R, 18G, and 18B are drawn as a liquid crystal panel 18. The screen S is disposed in the enlargement-side conjugate plane of the projection system 3, as shown in FIG. 2. The liquid crystal panel 18 is disposed in the reduction-side conjugate plane of the projection system 3.

In the following description, three axes perpendicular to one another are called axes X, Y, and Z for convenience. The direction along an optical axis N of the projection system 3 is called an axis-Z direction. The axis-Z direction toward the side where the screen S is located is called a first direction Z1, and the axis-Z direction toward the side where the liquid crystal panel 18 is located is called a second direction Z2. The axis Y extends along the screen S. The upward-downward direction is an axis-Y direction, with one side of the axis-Y direction called an upper side Y1 and the other side of the axis-Y direction called a lower side Y2. The axis X extends in the width direction of the screen.

The liquid crystal panel 18 disposed in the reduction-side conjugate plane forms a projection image at the lower side Y2 of the optical axis N of the projection system 3, as shown in FIG. 2. An enlarged image projected by the projection system 3 onto the screen S is formed at the upper side Y1 of the optical axis N.

Examples 1 to 7 will be described below as examples of the configuration of the projection system 3 incorporated in the projector 1.

### Example 1

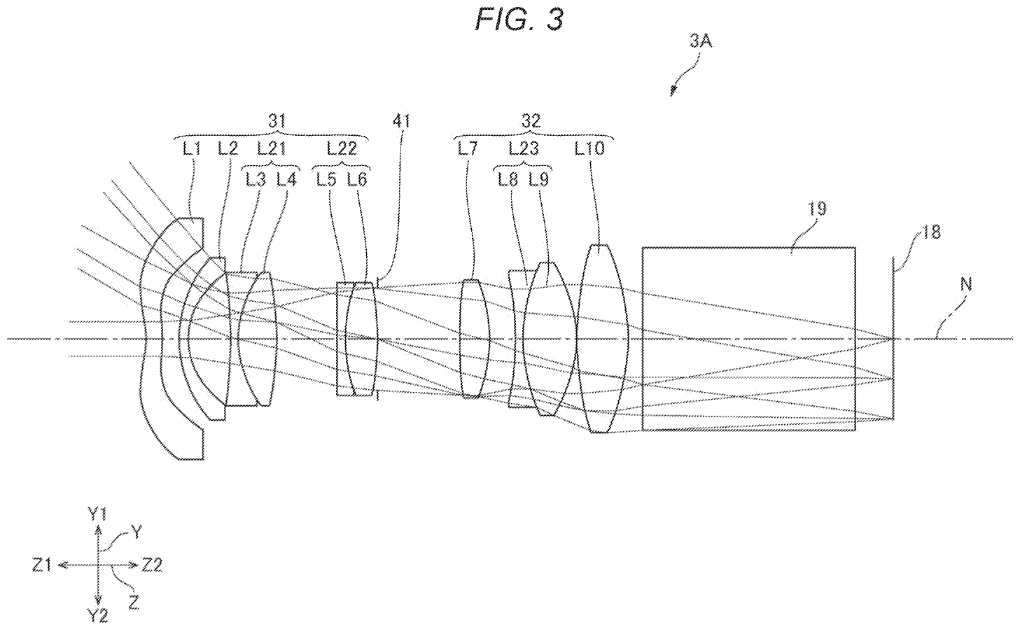

FIG. 3 is a beam diagram showing beams passing through a projection system 3A according to Example 1. The projection system 3A includes a first lens group 31 having positive power, an aperture stop 41, and a second lens group 32 having positive power sequentially arranged from the enlargement side toward the reduction side, as shown in FIG. 3. The aperture stop 41 is set to specify the brightness of the projection system 3A.

The first lens group 31 includes six lenses L1 to L6. The lenses L1 to L6 are arranged in this order from the enlargement side toward the reduction side.

The lens L1 (first lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides. The lens L2 (second lens) has negative power. The lens L2 is a meniscus lens. The lens L2 has a convex surface at the enlargement side and a concave surface at the reduction side.

The lens L3 (third lens) and the lens L4 (fourth lens) are bonded to each other into a cemented doublet L21. The lens L3 has negative power. The lens L3 has concave surfaces both at the enlargement and reduction sides. The lens L4 has positive power. The lens L4 has convex surfaces both at the enlargement and reduction sides. The lens L4 is a first positive lens disposed at a position closest to the enlargement side out of a plurality of positive lenses in the first lens group 31. The cemented doublet L21 has negative power.

The lens L5 (third lens) and the lens L6 (fourth lens) are bonded to each other into a cemented doublet L22. The lens L5 has negative power. The lens L5 is a meniscus lens. The lens L5 has a convex surface at the enlargement side and a concave surface at the reduction side. The lens L6 has positive power. The lens L6 has convex surfaces both at the enlargement and reduction sides. The lens L6 is a second positive lens disposed at a position closest to the reduction side out of the plurality of positive lenses in the first lens group 31. The cemented doublet L22 has positive power.

The second lens group 32 includes four lenses L7 to L10. The lenses L7 to L10 are arranged in this order from the enlargement side toward the reduction side.

The lens L7 has positive power. The lens L7 has convex surfaces both at the enlargement and reduction sides. The lens L7 has aspherical surfaces at opposite sides.

The lenses L8 and L9 are bonded to each other into a cemented doublet L23. The lens L8 has negative power. The lens L8 has concave surfaces both at the enlargement and reduction sides. The lens L9 has positive power. The lens L9 has convex surfaces both at the enlargement and reduction sides. The cemented doublet L23 has negative power.

The lens L10 (reduction-side lens) has positive power. The lens L10 has convex surfaces both at the enlargement and reduction sides.

The lens L1 is made of resin. The lenses L2 to L10 are made of glass.

In the projection system 3A, the portion at the reduction side of the lens L10 is a telecentric portion. The configuration in which the portion at the reduction side of the lens L10 is a telecentric portion means that the central beam of each luminous flux traveling along the path between the lens L10 and the liquid crystal panel 18 disposed in the reduction-side conjugate plane is parallel or substantially parallel to the optical axis N.

Data on the projection system 3A according to Example 1 are listed in a table below. In the table, FNo represents the f number of the projection system 3A, TTL represents the overall optical length, L represents the distance along the optical axis N from the enlargement-side surface of the lens L1 to the reduction-side surface of the lens L10, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L4, Fp2 represents the focal length of the lens L6, Fls represents the focal length of the lens L1, Flf represents the focal length of the lens L10, Fc represents the focal length of each of the cemented doublets L21 and L22, and LnθgF represents the partial dispersion ratio of the lens L2. The partial dispersion ratio θgF is determined by the following calculation expression:

θgF=(Ng−NF)/(NF−NC)
Ng: Refractive index of lens material at g line (435.8 nm)
NF: Refractive index of lens material at F line (486.1 nm)
NC: Refractive index of lens material at C line (656.3 nm)

| Fno | 2.008 | |
|---|---|---|
| TTL | 97.503 | mm |
| L | 63.003 | mm |
| Bf | 34.500 | mm |
| ω | 49.285° | |
| YIM | 10.350 | mm |
| F | 9.040 | mm |
| Fp1 | 18.248 | mm |
| Fp2 | 16.175 | mm |
| FLs | −39.576 | mm |
| FLf | 32.718 | mm |
| Fc (cemented doublet L21) | −47.268 | mm |
| Fc (cemented doublet L22) | 40.344 | mm |

| | |
|---|---|
| LnθgF | 0.640 |

Data on the lenses of the projection system 3A are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | T | nd | νd |
| S | 0 | inf | 10900.000 | | |
| L01 | 1* | −8.71 | 2.000 | 1.5311 | 55.8 |
| | 2* | −16.01 | 2.309 | | |
| L02 | 3 | 15.74 | 1.200 | 1.9229 | 20.9 |
| | 4 | 9.86 | 5.576 | | |
| L03 | 5 | −66.76 | 1.000 | 1.9108 | 35.3 |
| L04 | 6 | 13.88 | 5.000 | 1.5750 | 41.5 |
| | 7 | −38.10 | 7.692 | | |
| L05 | 8 | 214.97 | 1.200 | 1.9004 | 37.4 |
| L06 | 9 | 20.99 | 4.241 | 1.8697 | 20.0 |
| 41 | 10 | −39.85 | 0.000 | | |
| | 11 | inf | 10.645 | | |
| L07 | 12* | 68.80 | 3.952 | 1.4971 | 81.6 |
| | 13* | −17.98 | 3.432 | | |
| L08 | 14 | −32.73 | 1.000 | 2.0006 | 25.5 |
| L09 | 15 | 22.34 | 6.897 | 1.4970 | 81.5 |
| | 16 | −18.57 | 0.100 | | |
| L10 | 17 | 36.76 | 6.757 | 1.4970 | 81.5 |
| | 18 | −27.51 | 2.000 | | |
| 19 | 19 | inf | 27.43 | 1.5168 | 64.20 |
| | 20 | inf | 5.02 | | |
| 18 | 21 | inf | 0.05 | | |

The aspherical coefficients are listed below.

| Surface number | 1 | 2 |
|---|---|---|
| Conic constant | −3.94727E+00 | 0.00000E+00 |
| Third-order | 1.92451E+01 | 5.24169E+00 |
| coefficient | | |
| Fourth-order | 2.35446E+01 | 5.77383E+00 |
| coefficient | | |
| Fifth-order | −9.86182E+01 | 0.00000E+00 |
| coefficient | | |
| Sixth-order | 1.04199E+02 | −7.41862E+00 |
| coefficient | | |
| Seventh-order | −2.49990E+01 | 0.00000E+00 |
| coefficient | | |
| Eighth-order | −2.30073E+01 | 5.79088E+00 |
| coefficient | | |
| Ninth-order | 1.24751E+01 | 0.00000E+00 |
| coefficient | | |
| Tenth-order | −3.76952E−01 | −1.89317E+00 |
| coefficient | | |
| Eleventh-order | 0.00000E+00 | 0.00000E+00 |
| coefficient | | |
| Twelfth-order | 0.00000E+00 | 1.36389E-01 |
| coefficient | | |

| Surface number | 12 | 13 |
|---|---|---|
| Conic constant | −2.02750E+02 | 1.82648E+00 |
| Fourth-order | 8.77215E−05 | 9.26598E−05 |
| coefficient | | |
| Sixth-order | −1.18629E−06 | 3.79107E−07 |
| coefficient | | |
| Eighth-order | 1.58761E−08 | −4.57038E−09 |
| coefficient | | |
| Tenth-order | −1.75959E−10 | 6.13553E−11 |
| coefficient | | |
| Twelfth-order | 4.44227E−13 | −4.73005E−13 |
| coefficient | | |

The projection system 3A according to the present example satisfies Conditional Expressions (1) and (2) below,

LnθgF≥0.6 (1)

ω>40° (2)

where LnθgF represents the partial dispersion ratio of the lens L2, and ω represents the maximum half angle of view of the overall projection system.

In the present example,
LnθgF 0.640
ω 49.285°
   are satisfied. Therefore, since LnθgF=0.640, Conditional Expression (1) is satisfied. Since ω=49.285°, Conditional Expression (2) is satisfied.

The projection system 3A according to the present example satisfies Conditional Expression (3) below,

1.0<Fp1/F<6.0 (3)

where F represents the focal length of the overall projection system, and Fp1 represents the focal length of the lens L4.

In the present example,
F 9.040 mm
Fp1 18.248 mm
   are satisfied. Fp1/F=2.019 is therefore achieved, so that Conditional Expression (3) is satisfied.

The projection system 3A according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L10, F represents the focal length of the overall projection system, BF represents the back focal length in air, Fls represents the focal length of the lens L1, and Flf represents the focal length of the lens L10.

In the present example,

| | | |
|---|---|---|
| L | 63.003 | mm |
| F | 9.040 | mm |
| Bf | 34.500 | mm |
| Fls | −39.576 | mm |
| Flf | 32.718 | mm |

are satisfied. Therefore, L/F=6.969 is achieved, so that Conditional Expression (4) is satisfied. BF/F=3.816 is achieved, so that Conditional Expression (5) is satisfied. Fls/F=−4.378 is achieved, so that Conditional Expression (6) is satisfied. Flf/F=3.619 is achieved, so that Conditional Expression (7) is satisfied.

The projection system 3A according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,

| | |
|---|---|
| \| Δνd \| | 6.255 |
| \| Δnd \| | 0.336 |
| F | 9.040 mm |
| Fc (cemented doublet L21) | −47.268 mm |

are satisfied. Therefore, |Δνd|=6.255 is provided, so that Conditional Expression (8) is satisfied. |Δnd|=0.336 is provided, so that Conditional Expression (9) is satisfied. |Fc/F|=5.229 is achieved, so that Conditional Expression (10) is satisfied.

Similarly, the projection system 3A according to the present example satisfies all Conditional Expressions (8), (9), and (10) described above, where F represents the focal length of the overall projection system, A-νd represents the difference in Abbe number at the d line between the lenses L5 and L6, And represents the difference in refractive index at the d line between the lenses L5 and L6, and Fc represents the focal length of the cemented doublet L22.

In the present example,

| | |
|---|---|
| \| Δνd \| | 17.350 |
| \| Δnd \| | 0.031 |
| F | 9.040 mm |
| Fc (cemented doublet L22) | 40.344 mm |

are satisfied. Therefore, |Δνd|=17.350 is provided, so that Conditional Expression (8) is satisfied. |Δηd|=0.031 is provided, so that Conditional Expression (9) is satisfied. |Fc/F|=4.463 is achieved, so that Conditional Expression (10) is satisfied.

The projection system 3A according to the present example satisfies Conditional Expressions (11) and (12) below,

νdp2<40 (11)

1.5<Fp2/F<15.0 (12)

where F represents the focal length of the overall projection system, Fp2 represents the focal length of the lens L6, and νdp2 represents the Abbe number of the lens L6 at the d line.

In the present example,
νdp2 20.020
F 9.040 mm
Fp2 16.175 mm
   are satisfied. Therefore, νdp2=20.020 is provided, so that Conditional Expression (11) is satisfied. Fp2/F=1.789 is achieved, so that Conditional Expression (12) is satisfied.

### Effects and Advantages

The projection system 3A according to the present example, which satisfies Conditional Expression (2), can be a wide-angle projection system. When the projection system 3A according to the present example satisfies Conditional Expression (2), the positive lenses of the first lens group 31 are likely to produce a chromatic aberration of magnification. The projection system 3A according to the present example, which satisfies Conditional Expression (1), however, can suppress the chromatic aberration of magnification produced by the lenses L4 and L6 of the first lens group 31 with the maximum half angle of view being greater than 40°. That is, when the value of Conditional Expression (1) is smaller than the lower limit, it is difficult to suppress the chromatic aberration of magnification produced by the lenses L4 and L6 of the first lens group 31.

The projection system 3A according to the present example satisfies Conditional Expression (3) below,

1.0<Fp1/F<6.0 (3)

where F represents the focal length of the overall projection system, and Fp1 represents the focal length of the lens L4.

The projection system 3A according to the present example, which satisfies Conditional Expression (3), can suppress a variety of types of aberrations produced by the lens L4 with the radial size of the projection system 3A reduced. That is, when the value of Conditional Expression (3) is smaller than the lower limit, the lens L4 has too large power. The radial sizes of the first and second lenses can therefore be reduced, so can the radial size of the projection system 3A, but the aberrations produced by the lens L4 increase. On the other hand, when the value of Conditional Expression (3) is greater than the upper limit, the power of the lens L4 decreases, so that the aberrations produced by the lens L4 decrease, but the radial sizes of the first and second lenses increase, so does the outer diameter of projection system 3A.

In the present example, the lens L1 has negative power. The maximum half angle of view of the projection system 3A is therefore readily increased. In the present example, the lens L10 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are negative lenses disposed in succession from a position closest to the enlargement side toward the reduction side. The lens L1 is an aspherical lens made of plastic. According to the configuration described above, image curvature produced by the projection system 3A can be suppressed.

The projection system 3A according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L10, F represents the focal length of the overall projection system, BF represents the back focal length in air, Fls represents the focal length of the lens L1, and Flf represents the focal length of the lens L10.

The projection system 3A according to the present example, which satisfies Conditional Expression (4), can ensure the image formation performance of the projection system 3A with the overall length thereof reduced. That is, when the value of Conditional Expression (4) is smaller than the lower limit, the distance from the lens closest to the enlargement side to the lens closest to the reduction side is too short. The overall length of the projection system 3A can thus be reduced, but the number of lenses required to ensure the image formation performance of the projection system 3A cannot be achieved. When the value of Conditional Expression (4) is greater than the upper limit, the distance is too long. The number of lenses required to ensure the image formation performance of the projection system 3A is thus achieved, but the overall length of the projection system 3A increases.

The projection system 3A, which satisfies Conditional Expression (5), readily ensures a sufficient back focal length. That is, when the value of Conditional Expression (5) is smaller than the lower limit, the back focal length is too short, and it is therefore difficult to provide a space for a light combining prism, compensators for the liquid crystal panels, and other components disposed at the reduction side of the second lens group 32. It is further difficult for the portion at the reduction side of the second lens group 32 to serve as a telecentric portion.

Furthermore, the projection system 3A according to the present example, which satisfies Conditional Expression (6), can ensure the image formation performance of the projection system 3A while ensuring a sufficient back focal length. That is, when the value of Conditional Expression (6) is smaller than the lower limit, the focal length Fls of the lens L1 is too short. The image formation performance of the projection system 3A can thus be ensured, but the power of the lens L1 increases, so that it is difficult to provide a sufficiently long back focal length. When the value of Conditional Expression (6) is greater than the upper limit, the focal length Fls of the lens L1 is too long. The power of the lens L1 thus decreases, so that the image formation performance of the projection system 3A deteriorates while a sufficiently long back focal length is provided.

The projection system 3A according to the present example, which satisfies Conditional Expression (7), can ensure the image formation performance of the projection system 3A with the portion at the reduction side of the second lens group 32 serving as a telecentric portion. That is, when the value of Conditional Expression (7) is smaller than the lower limit, the focal length Flf of the lens L10 is too short. The image formation performance of the projection system 3A can thus be ensured, but the power of the lens L11 increases, and it is difficult for the reduction side of the second lens group 32 to serve as a telecentric portion. When the value of Conditional Expression (7) is greater than the upper limit, the focal length Flf of the lens L10 is too long. The power of the lens L10 thus decreases, so that the image formation performance of the projection system 3A deteriorates while the reduction side of the second lens group 32 readily serves as a telecentric portion.

The projection system 3A according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

Similarly, the projection system 3A according to the present example satisfies all Conditional Expressions (8), (9), and (10) described above, where F represents the focal length of the overall projection system, Δνd represents the difference in Abbe number at the d line between the lenses L5 and L6, And represents the difference in refractive index at the d line between the lenses L5 and L6, and Fc represents the focal length of the cemented doublet L22.

The projection system 3A, which satisfies Conditional Expressions (8) and (9), can suppress the production of the chromatic aberration of magnification. That is, when the values of Conditional Expressions (8) and (9) are greater than the upper limits or smaller than the lower limits, it is difficult to suppress the production of the chromatic aberration of magnification.

The projection system 3A, which satisfies Conditional Expression (10), can have a short overall length while satisfactorily correcting the chromatic aberration of magnification. That is, when the value of Conditional Expression (10) is smaller than the lower limit, the focal length Fc of the cemented doublet L21 is too short. The power of the cemented doublet L21 thus increases, so that the chromatic aberration of magnification can be satisfactorily corrected, and the overall length of the projection system 3A can be shortened, but the aberrations are likely to be produced. When the value of Conditional Expression (10) is greater than the upper limit, the focal length Fc of the cemented doublet L21 is too long. The power of the cemented doublet L21 therefore decreases, so that the production of the aberrations can be suppressed, but the chromatic aberration of magnification cannot be satisfactorily corrected, and the overall length of the projection system 3A increases.

The projection system 3A according to the present example satisfies Conditional Expressions (11) and (12) below,

νdp2<40 (11)

1.5<Fp2/F<15.0 (12)

where F represents the focal length of the overall projection system, Fp2 represents the focal length of the lens L6, and νdp2 represents the Abbe number of the lens L6 at the d line.

The projection system 3A according to the present example, which satisfies Conditional Expression (11), can satisfactorily correct the chromatic aberration of magnification produced by the lens L1. That is, since the lens L6 is a positive lens disposed at a position closest to the aperture stop 41 and is made of a highly dispersive material, the lens L6 can cancel the chromatic aberration of magnification generated by the lens L1.

The projection system 3A according to the present example, which satisfies Conditional Expression (12), can suppress the aberrations produced by the lens L6 while satisfactorily correcting the chromatic aberration of magnification produced by the lens L1. That is, when the value of Conditional Expression (12) is smaller than the lower limit, the focal length Fp2 of the lens L6 is too short. The power of the lens L6 thus increases, so that the chromatic aberration of magnification produced by the lens L1 can be satisfactorily corrected, but the lens L6 is likely to produce the aberrations. When the value of Conditional Expression (12) is greater than the upper limit, the focal length Fp of the lens L6 is too long. The power of the lens L6 thus decreases, so that the aberrations produced by the lens L6 can be satisfactorily corrected, but the chromatic aberration of magnification produced by the lens L1 cannot be satisfactorily corrected.

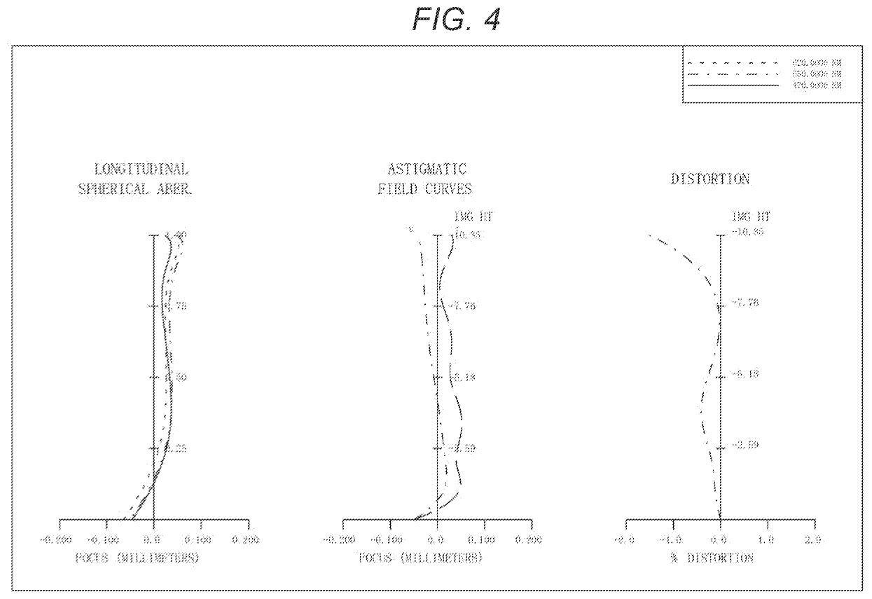

FIG. 4 shows the spherical aberration, astigmatism, and distortion produced by the projection system 3A. The projection system 3A according to the present example allows suppression of the aberrations that degrade an enlarged image, as shown in FIG. 4.

### Example 2

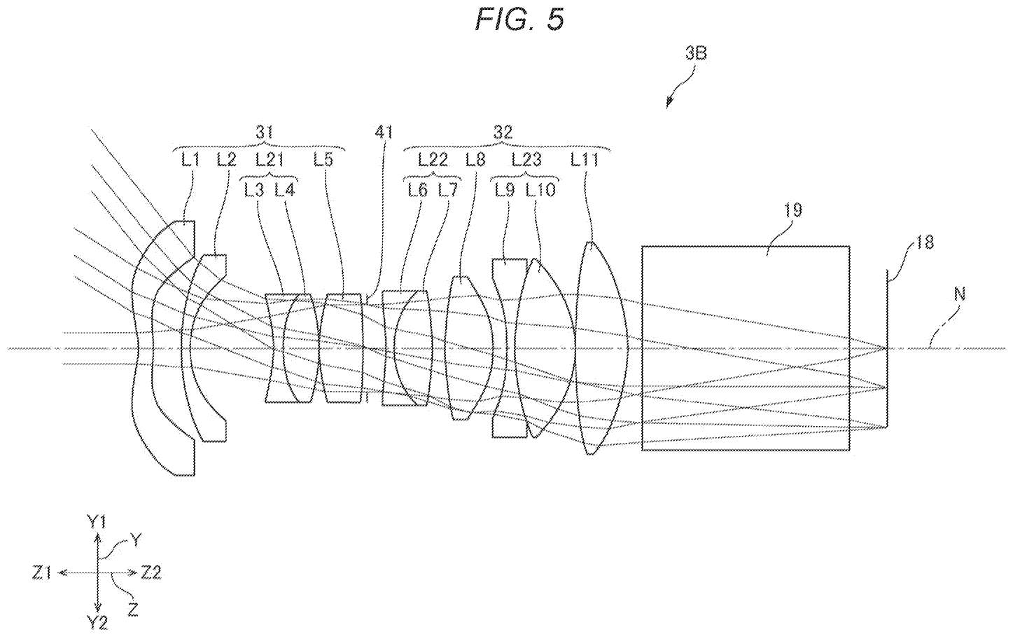

FIG. 5 is a beam diagram showing beams passing through a projection system 3B according to Example 2. The projection system 3B includes a first lens group 31 having positive power, an aperture stop 41, and a second lens group 32 having positive power sequentially arranged from the enlargement side toward the reduction side, as shown in FIG. 5. The aperture stop 41 is set to specify the brightness of the projection system 3B.

The first lens group 31 includes five lenses L1 to L5. The lenses L1 to L5 are arranged in this order from the enlargement side toward the reduction side.

The lens L1 (first lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides. The lens L2 (second lens) has negative power. The lens L2 is a meniscus lens. The lens L2 has a convex surface at the enlargement side and a concave surface at the reduction side.

The lens L3 (third lens) and the lens L4 (fourth lens) are bonded to each other into a cemented doublet L21. The lens L3 has negative power. The lens L3 has concave surfaces both at the enlargement and reduction sides. The lens L4 has positive power. The lens L4 has convex surfaces both at the enlargement and reduction sides. The lens L4 is a first positive lens disposed at a position closest to the enlargement side out of a plurality of positive lenses in the first lens group 31. The cemented doublet L21 has negative power.

The lens L5 has positive power. The lens L5 has convex surfaces both at the enlargement and reduction sides. The lens L5 is a second positive lens disposed at a position closest to the reduction side out of the plurality of positive lenses in the first lens group 31.

The second lens group 32 includes six lenses L6 to L11. The lenses L6 to L11 are arranged in this order from the enlargement side toward the reduction side.

The lenses L6 and L7 are bonded to each other into a cemented doublet L22. The lens L6 has negative power. The lens L6 has concave surfaces both at the enlargement and reduction sides. The lens L7 has positive power. The lens L7 has convex surfaces both at the enlargement and reduction sides. The cemented doublet L22 has negative power.

The lens L8 has positive power. The lens L8 has convex surfaces both at the enlargement and reduction sides. The lens L8 has aspherical surfaces at opposite sides.

The lenses L9 and L10 are bonded to each other into a cemented doublet L23. The lens L9 has negative power. The lens L9 has concave surfaces both at the enlargement and reduction sides. The lens L10 has positive power. The lens L10 has convex surfaces both at the enlargement and reduction sides. The lens L10 has an aspherical surface at the reduction side. The cemented doublet L23 has negative power.

The lens L11 (reduction-side lens) has positive power. The lens L11 has convex surfaces both at the enlargement and reduction sides.

The lens L1 is made of resin. The lenses L2 to L11 are made of glass.

In the projection system 3B, the portion at the reduction side of the lens L11 is a telecentric portion.

Data on the projection system 3B according to Example 2 are listed in a table below. In the table, FNo represents the f number of the projection system 3B, TTL represents the overall optical length, L represents the distance along the optical axis N from the enlargement-side surface of the lens L1 to the reduction-side surface of the lens L11, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L4, Fp2 represents the focal length of the lens L5, Fls represents the focal length of the lens L1, Flf represents the focal length of the lens L11, Fc represents the focal length of the cemented doublet L21, and LnθgF represents the partial dispersion ratio of the lens L2.

| Fno | 2.000 | |
|---|---|---|
| TTL | 99.505 | mm |
| L | 65.000 | mm |
| Bf | 34.505 | mm |
| ω | 50.285° | |
| YIM | 10.350 | mm |
| F | 8.353 | mm |
| Fp1 | 12.324 | mm |
| Fp2 | 26.826 | mm |
| FLs | −38.967 | mm |
| FLf | 36.884 | mm |
| Fc | −99.855 | mm |

| | |
|---|---|
| LnθgF | 0.640 |

Data on the lenses of the projection system 3B are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | D | nd | νd |
| S | 0 | inf | 10900.000 | | |
| L01 | 1* | −8.14 | 2.000 | 1.5311 | 55.8 |
| | 2* | −14.53 | 3.787 | | |
| L02 | 3 | 27.80 | 1.206 | 1.9229 | 20.9 |
| | 4 | 12.03 | 11.013 | | |
| L03 | 5 | −19.85 | 1.200 | 1.7725 | 49.6 |
| L04 | 6 | 12.60 | 4.818 | 1.6889 | 31.1 |
| | 7 | −22.43 | 0.100 | | |
| L05 | 8 | 25.56 | 5.807 | 1.7283 | 28.5 |
| | 9 | −77.33 | 0.574 | | |
| 41 | 10 | inf | 2.483 | | |
| L06 | 11 | −36.11 | 1.000 | 1.9537 | 32.3 |
| L07 | 12 | 10.64 | 5.023 | 1.7847 | 25.7 |
| | 13 | −42.29 | 1.815 | | |
| L08 | 14* | 41.75 | 6.298 | 1.4971 | 81.6 |
| | 15* | −13.75 | 1.895 | | |
| L09 | 16 | −23.31 | 1.000 | 2.0006 | 25.5 |
| L10 | 17 | 29.95 | 7.999 | 1.4971 | 81.6 |
| | 18* | −15.31 | 0.100 | | |
| L11 | 19 | 69.43 | 6.88 | 1.4970 | 81.5 |
| | 20 | −24.17 | 2.00 | | |
| 19 | 21 | inf | 27.43 | 1.5168 | 64.2 |
| | 22 | inf | 5.03 | | |
| 18 | 23 | inf | 0.05 | | |

The aspherical coefficients are listed below.

| Surface number | 1 | 2 |
|---|---|---|
| Conic constant | −3.55898E+00 | −3.59351E−02 |
| Third-order | 2.03084E+01 | 9.32258E+00 |
| coefficient | | |
| Fourth-order | 1.99441E+01 | 1.12957E+01 |
| coefficient | | |
| Fifth-order | −9.32560E+01 | −1.57267E+00 |
| coefficient | | |
| Sixth-order | 1.00422E+02 | −1.75079E+01 |
| coefficient | | |
| Seventh-order | −2.57668E+01 | 2.01490E+00 |
| coefficient | | |
| Eighth-order | −2.17920E+01 | 1.55978E+01 |
| coefficient | | |
| Ninth-order | 1.28981E+01 | −4.65184E−01 |
| coefficient | | |
| Tenth-order | −5.46354E−01 | −5.36687E+00 |
| coefficient | | |

| Surface number | 14 | 15 | 18 |
|---|---|---|---|
| Conic constant | 6.77949E+00 | −2.54428E−01 | −1.63386E+00 |
| Fourth-order | −1.21234E−05 | 6.23756E−05 | −4.75133E−05 |
| coefficient | | | |
| Sixth-order | −7.57407E−08 | −2.01718E−07 | 0.00000E+00 |
| coefficient | | | |
| Eighth-order | −2.10980E−09 | −2.37450E−09 | 0.00000E+00 |
| coefficient | | | |
| Tenth-order | 2.16919E−11 | 8.17896E−12 | 0.00000E+00 |
| coefficient | | | |
| Twelfth-order | −4.85082E−14 | 0.00000E+00 | 0.00000E+00 |
| coefficient | | | |

The projection system 3B according to the present example satisfies Conditional Expressions (1) and (2) below,

LnθgF≥0.6 (1)

ω>40° (2)

where LnθgF represents the partial dispersion ratio of the lens L2, and ω represents the maximum half angle of view of the overall projection system.

In the present example,
LnθgF 0.640
ω 50.285°
   are satisfied. Therefore, since LnθgF=0.640, Conditional Expression (1) is satisfied. Since ω=50.285°, Conditional Expression (2) is satisfied.

The projection system 3B according to the present example satisfies Conditional Expression (3) below,

1.0<Fp1/F<6.0 (3)

where F represents the focal length of the overall projection system, and Fp1 represents the focal length of the lens L4.

In the present example,
F 8.353 mm
Fp1 12.324 mm
   are satisfied. Fp1/F=1.475 is therefore achieved, so that Conditional Expression (3) is satisfied.

The projection system 3B according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L11, F represents the focal length of the overall projection system, BF represents the back focal length in air, Fls represents the focal length of the lens L1, and Flf represents the focal length of the lens L11.

In the present example,

| | | |
|---|---|---|
| L | 65.000 | mm |
| F | 8.353 | mm |
| Bf | 34.505 | mm |
| Fls | −38.967 | mm |
| Flf | 36.884 | mm |

are satisfied. Therefore, L/F=7.781 is achieved, so that Conditional Expression (4) is satisfied. BF/F=4.131 is achieved, so that Conditional Expression (5) is satisfied. Fls/F=−4.665 is achieved, so that Conditional Expression (6) is satisfied. Flf/F=4.415 is achieved, so that Conditional Expression (7) is satisfied.

The projection system 3B according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,
   |Δνd|18.523
   |Δnd| 0.084
F 8.353 mm
Fc −99.855 mm
   are satisfied. Therefore, |Δνd|=18.523 is provided, so that Conditional Expression (8) is satisfied. |Δnd|=0.084 is provided, so that Conditional Expression (9) is satisfied. |Fc/F|=3.211 is achieved, so that Conditional Expression (10) is satisfied.

The projection system 3B according to the present example satisfies Conditional Expressions (11) and (12) below,

νdp2<40 (11)

1.5<Fp2/F<15.0 (12)

where F represents the focal length of the overall projection system, Fp2 represents the focal length of the lens L5, and νdp2 represents the Abbe number of the lens L5 at the d line.

In the present example,
νdp2 28.460
F 8.353 mm
Fp2 26.826 mm
   are satisfied. Therefore, νdp2=28.460 is provided, so that Conditional Expression (11) is satisfied. Fp2/F=3.211 is achieved, so that Conditional Expression (12) is satisfied.

### Effects and Advantages

The projection system 3B according to the present example, which satisfies Conditional Expressions (1) to (12), can provide the same effects and advantages as those provided by the projection system 3A according to Example 1.

In the projection system 3B according to the present example, the lens L1 has negative power. The maximum half angle of view of the projection system 3B is therefore readily increased. In the present example, the lens L11 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are each a negative lens having negative power. The lens L1 is an aspherical lens made of plastic. According to the configuration described above, image curvature produced by the projection system 3B can be suppressed.

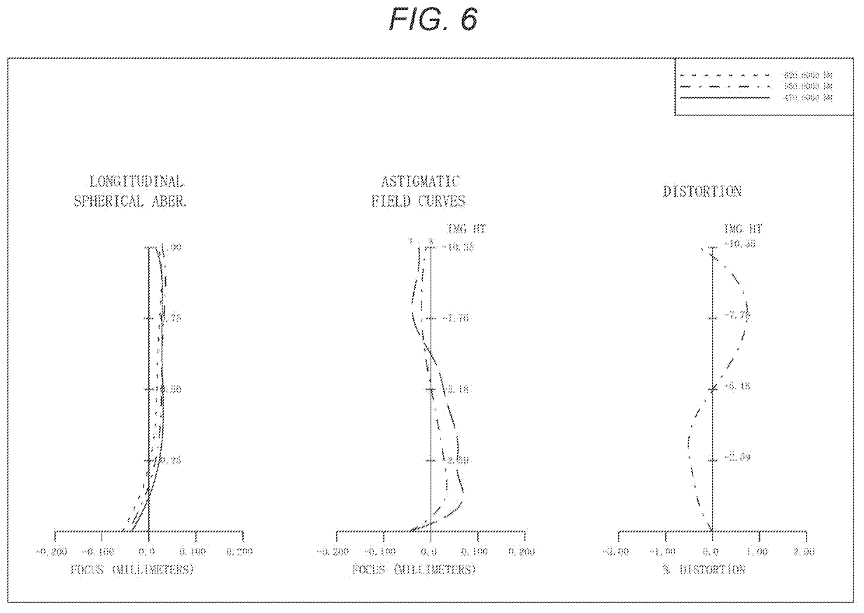

FIG. 6 shows the spherical aberration, astigmatism, and distortion produced by the projection system 3B. The projection system 3B according to the present example allows suppression of the aberrations that degrade an enlarged image, as shown in FIG. 6.

### Example 3

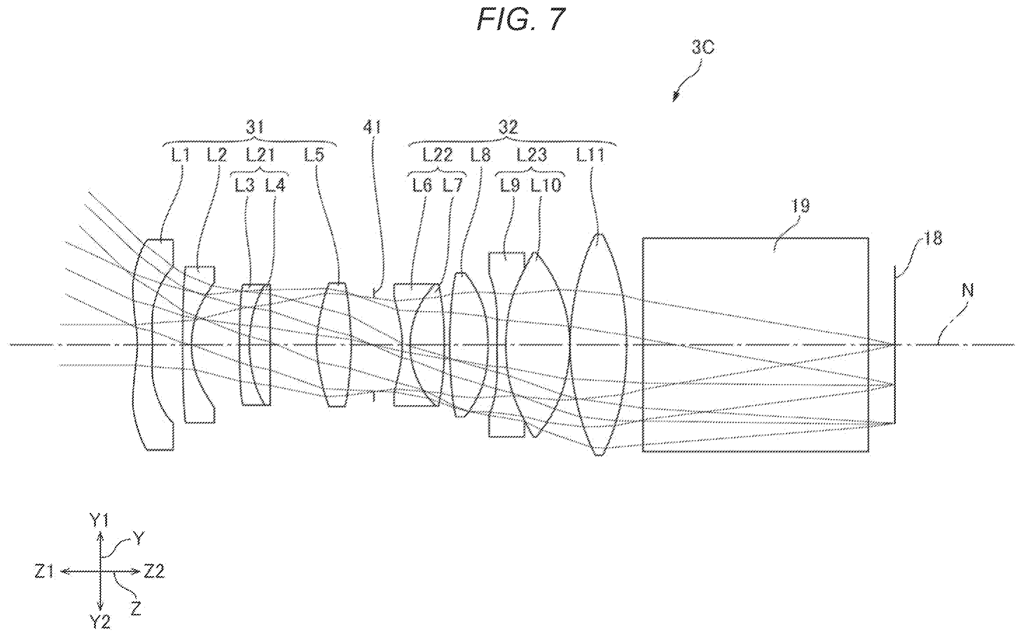

FIG. 7 is a beam diagram showing beams passing through a projection system 3C according to Example 3. The projection system 3C includes a first lens group 31 having positive power, an aperture stop 41, and a second lens group 32 having positive power sequentially arranged from the enlargement side toward the reduction side, as shown in FIG. 7. The aperture stop 41 is set to specify the brightness of the projection system 3C.

The first lens group 31 includes five lenses L1 to L5. The lenses L1 to L5 are arranged in this order from the enlargement side toward the reduction side.

The lens L1 (first lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides. The lens L2 (second lens) has negative power. The lens L2 is a meniscus lens. The lens L2 has a convex surface at the enlargement side and a concave surface at the reduction side.

The lens L3 (third lens) and the lens L4 (fourth lens) are bonded to each other into a cemented doublet L21. The lens L3 has negative power. The lens L3 is a meniscus lens. The lens L3 has a convex surface at the enlargement side and a concave surface at the reduction side. The lens L4 has positive power. The lens L4 has convex surfaces both at the enlargement and reduction sides. The lens L4 is a first positive lens disposed at a position closest to the enlargement side out of a plurality of positive lenses in the first lens group 31. The cemented doublet L21 has positive power.

The lens L5 has positive power. The lens L5 has convex surfaces both at the enlargement and reduction sides. The lens L5 is a second positive lens disposed at a position closest to the reduction side out of the plurality of positive lenses in the first lens group 31.

The second lens group 32 includes six lenses L6 to L11. The lenses L6 to L11 are arranged in this order from the enlargement side toward the reduction side.

The lenses L6 and L7 are bonded to each other into a cemented doublet L22. The lens L6 has negative power. The lens L6 has concave surfaces both at the enlargement and reduction sides. The lens L7 has positive power. The lens L7 has convex surfaces both at the enlargement and reduction sides. The cemented doublet L22 has negative power.

The lens L8 has positive power. The lens L8 has convex surfaces both at the enlargement and reduction sides. The lens L8 has aspherical surfaces at opposite sides.

The lenses L9 and L10 are bonded to each other into a cemented doublet L23. The lens L9 has negative power. The lens L9 has concave surfaces both at the enlargement and reduction sides. The lens L10 has positive power. The lens L10 has convex surfaces both at the enlargement and reduction sides. The lens L10 has an aspherical surface at the reduction side. The cemented doublet L23 has negative power.

The lens L11 (reduction-side lens) has positive power. The lens L11 has convex surfaces both at the enlargement and reduction sides.

The lens L1 is made of resin. The lenses L2 to L11 are made of glass.

In the projection system 3C, the portion at the reduction side of the lens L11 is a telecentric portion.

Data on the projection system 3C according to Example 3 are listed in a table below. In the table, FNo represents the f number of the projection system 3C, TTL represents the overall optical length, L represents the distance along the optical axis N from the enlargement-side surface of the lens L1 to the reduction-side surface of the lens L11, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L4, Fp2 represents the focal length of the lens L5, Fls represents the focal length of the lens L1, Flf represents the focal length of the lens L11, Fc represents the focal length of the cemented doublet L21, and LnθgF represents the partial dispersion ratio of the lens L2.

| Fno | 2.000 | |
|---|---|---|
| TTL | 97.584 | mm |
| L | 63.084 | mm |
| Bf | 34.500 | mm |
| ω | 43.461° | |
| YIM | 10.350 | mm |
| F | 10.841 | mm |
| Fp1 | 20.677 | mm |
| Fp2 | 21.158 | mm |
| FLs | −36.106 | mm |
| FLf | 35.530 | mm |
| Fc | 80.606 | mm |

| | |
|---|---|
| LnθgF | 0.604 |

Data on the lenses of the projection system 3C are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | D | nd | νd |
| S | 0 | inf | 10900.000 | | |
| L01 | 1* | −10.05 | 2.000 | 1.5311 | 55.8 |
| | 2* | −22.46 | 3.961 | | |
| L02 | 3 | 153.16 | 1.200 | 1.7174 | 29.5 |
| | 4 | 12.88 | 6.315 | | |
| L03 | 5 | 93.69 | 1.200 | 1.6968 | 55.5 |
| L04 | 6 | 16.07 | 2.724 | 1.7380 | 32.3 |
| | 7 | −322.34 | 6.004 | | |
| L05 | 8 | 21.04 | 4.371 | 1.6889 | 31.1 |
| | 9 | −44.40 | 2.730 | | |
| 41 | 10 | inf | 3.605 | | |
| L06 | 11 | −18.93 | 1.000 | 1.9037 | 31.3 |
| L07 | 12 | 11.12 | 4.572 | 1.6889 | 31.1 |
| | 13 | −36.72 | 0.677 | | |
| L08 | 14* | 52.69 | 4.974 | 1.4971 | 81.6 |
| | 15* | −15.89 | 1.162 | | |
| L09 | 16 | −43.88 | 1.000 | 1.9053 | 35.0 |
| L10 | 17 | 21.22 | 8.123 | 1.4971 | 81.6 |
| | 18* | −19.28 | 0.100 | | |
| L11 | 19 | 33.48 | 7.37 | 1.4970 | 81.55 |
| | 20 | −34.83 | 2.00 | | |
| 19 | 21 | inf | 29.00 | 1.52 | 64.20 |
| | 22 | inf | 3.45 | | |
| 18 | 23 | inf | 0.05 | | |

The aspherical coefficients are listed below.

| Surface number | 1 | 2 |
|---|---|---|
| Conic constant | −4.19368E+00 | 3.02766E−01 |
| Third-order | 4.04179E−03 | 4.15623E−03 |
| coefficient | | |
| Fourth-order | 2.81913E−04 | 3.65057E−04 |
| coefficient | | |
| Fifth-order | −7.62784E−05 | −4.99132E−06 |
| coefficient | | |
| Sixth-order | 4.96033E−06 | −4.33606E−06 |
| coefficient | | |
| Seventh-order | −7.81377E−08 | 5.04518E−08 |
| coefficient | | |
| Eighth-order | −4.00564E−09 | 2.54038E−08 |
| coefficient | | |
| Ninth-order | 1.38336E−10 | −2.11296E−10 |
| coefficient | | |
| Tenth-order | −8.83014E−13 | −7.35684E−11 |
| coefficient | | |

| Surface number | 14 | 15 | 18 |
|---|---|---|---|
| Conic constant | 1.11956E+01 | 1.99883E−02 | −1.92388E+00 |
| Fourth-order | 1.43238E−06 | 4.10671E−05 | −3.56412E−05 |
| coefficient | | | |
| Sixth-order | −5.09171E−08 | −7.26994E−08 | 0.00000E+00 |
| coefficient | | | |
| Eighth-order | −2.56828E−09 | −3.42058E−09 | 0.00000E+00 |
| coefficient | | | |
| Tenth-order | 9.96162E−12 | −3.59619E−12 | 0.00000E+00 |
| coefficient | | | |
| Twelfth-order | 8.49426E−14 | 0.00000E+00 | 0.00000E+00 |
| coefficient | | | |

The projection system 3C according to the present example satisfies Conditional Expressions (1) and (2) below,

LnθgF≥0.6 (1)

ω>40° (2)

where LnθgF represents the partial dispersion ratio of the lens L2, and ω represents the maximum half angle of view of the overall projection system.

In the present example,
LnθgF 0.604
ω 43.461°
   are satisfied. Therefore, since LnθgF=0.604, Conditional Expression (1) is satisfied. Since ω=43.461°, Conditional Expression (2) is satisfied.

The projection system 3C according to the present example satisfies Conditional Expression (3) below,

1.0<Fp1/F<6.0 (3)

where F represents the focal length of the overall projection system, and Fp1 represents the focal length of the lens L4.

In the present example,
F 10.841 mm
Fp1 20.677 mm
   are satisfied. Fp1/F=1.907 is therefore achieved, so that Conditional Expression (3) is satisfied.

The projection system 3C according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L11, F represents the focal length of the overall projection system, BF represents the back focal length in air, Fls represents the focal length of the lens L1, and Flf represents the focal length of the lens L11.

In the present example,
L 63.084 mm
F 10.841 mm
Bf 34.500 mm
Fls −36.106 mm
Flf 35.530 mm
   are satisfied. Therefore, L/F=5.819 is achieved, so that Conditional Expression (4) is satisfied. BF/F=3.183 is achieved, so that Conditional Expression (5) is satisfied. Fls/F=−3.331 is achieved, so that Conditional Expression (6) is satisfied. Flf/F=3.278 is achieved, so that Conditional Expression (7) is satisfied.

The projection system 3C according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,
   |Δνd| 23.271
   |Δnd| 0.041
F 10.841 mm
Fc 80.606 mm
   are satisfied. Therefore, |Δνd|=23.271 is provided, so that Conditional Expression (8) is satisfied. |Δnd|=0.041 is provided, so that Conditional Expression (9) is satisfied. |Fc/F|=7.436 is achieved, so that Conditional Expression (10) is satisfied.

The projection system 3C according to the present example satisfies Conditional Expressions (11) and (12) below,

νdp2<40 (11)

1.5<Fp2/F<15.0 (12)

where F represents the focal length of the overall projection system, Fp2 represents the focal length of the lens L5, and νdp2 represents the Abbe number of the lens L5 at the d line.

In the present example,
νdp2 31.076
F 10.841 mm
Fp2 21.158 mm
   are satisfied. Therefore, νdp2=31.076 is provided, so that Conditional Expression (11) is satisfied. Fp2/F=1.952 is achieved, so that Conditional Expression (12) is satisfied.

### Effects and Advantages

The projection system 3C according to the present example, which satisfies Conditional Expressions (1) to (12), can provide the same effects and advantages as those provided by the projection system 3A according to Example 1.

In the projection system. 3C according to the present example, the lens L1 has negative power. The maximum half angle of view of the projection system 3C is therefore readily increased. In the present example, the lens L11 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are each a negative lens having negative power. The lens L1 is an aspherical lens made of plastic. According to the configuration described above, image curvature produced by the projection system 3C can be suppressed.

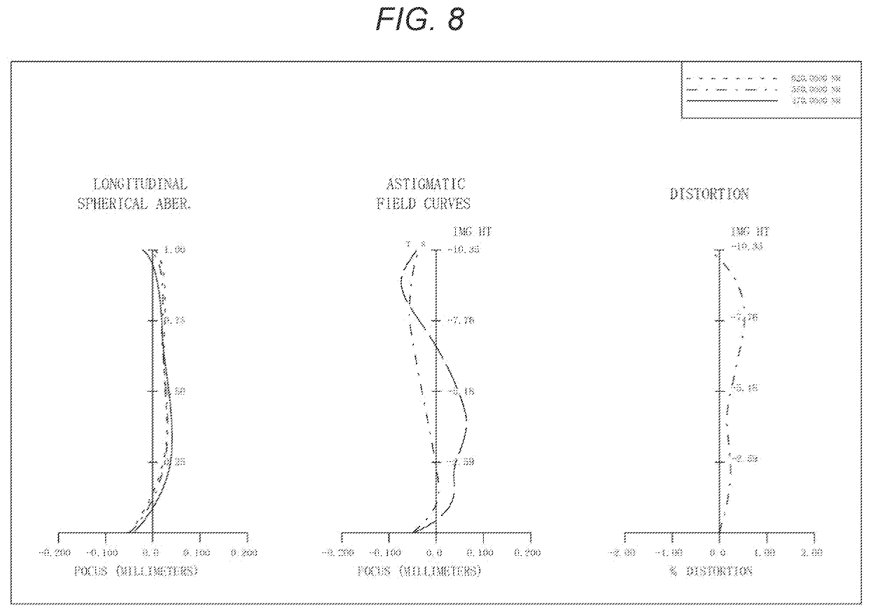

FIG. 8 shows the spherical aberration, astigmatism, and distortion produced by the projection system 3C. The projection system 3C according to the present example allows suppression of the aberrations that degrade an enlarged image, as shown in FIG. 8.

### Example 4

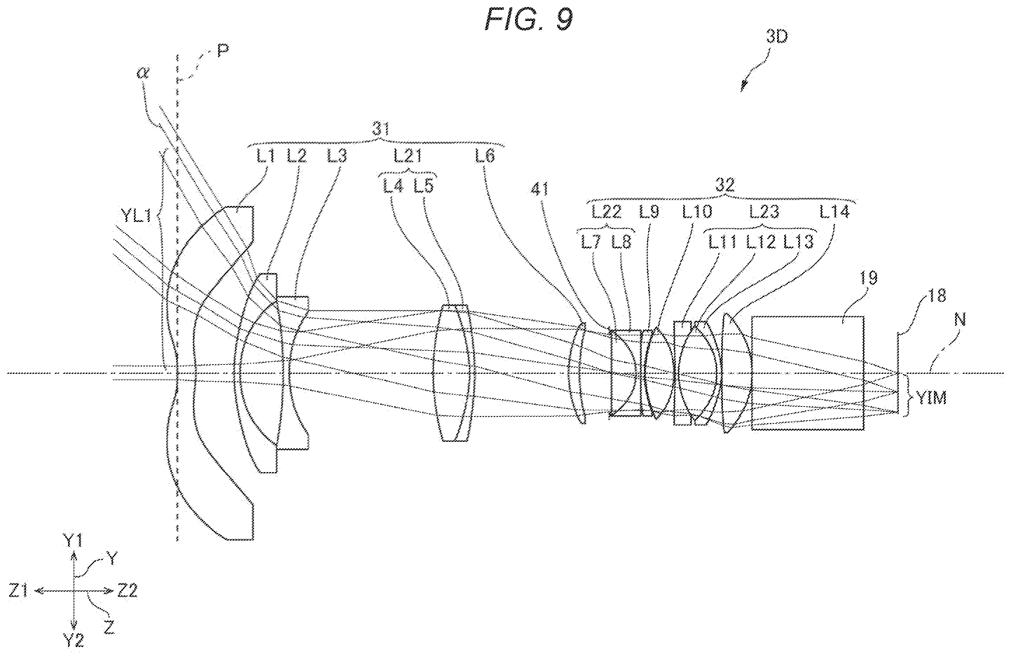

FIG. 9 is a beam diagram showing beams passing through a projection system 3D according to Example 4. The projection system 3D includes a first lens group 31 having positive power, an aperture stop 41, and a second lens group 32 having positive power sequentially arranged from the enlargement side toward the reduction side, as shown in FIG. 9. The aperture stop 41 is set to specify the brightness of the projection system 3D.

The first lens group 31 includes five lenses L1 to L5. The lenses L1 to L5 are arranged in this order from the enlargement side toward the reduction side.

The lens L1 (first lens) has negative power. The lens L1 is a meniscus lens. The lens L1 has a convex surface at the enlargement side and a concave surface at the reduction side. The lens L2 (second lens) has negative power. The lens L2 is a meniscus lens. The lens L2 has a convex surface at the enlargement side and a concave surface at the reduction side. The lens L2 has aspherical surfaces at opposite sides.

The lens L3 (third lens) and the lens L4 (fourth lens) are bonded to each other into a cemented doublet L21. The lens L3 has negative power. The lens L3 is a meniscus lens. The lens L3 has a convex surface at the enlargement side and a concave surface at the reduction side. The lens L4 has positive power. The lens L4 has convex surfaces both at the enlargement and reduction sides. The lens L4 is a first positive lens disposed at a position closest to the enlargement side out of a plurality of positive lenses in the first lens group 31. The cemented doublet L21 has positive power.

The lens L5 has positive power. The lens L5 has convex surfaces both at the enlargement and reduction sides. The lens L5 is a second positive lens disposed at a position closest to the reduction side out of the plurality of positive lenses in the first lens group 31.

The second lens group 32 includes six lenses L6 to L11. The lenses L6 to L11 are arranged in this order from the enlargement side toward the reduction side.

The lenses L6 and L7 are bonded to each other into a cemented doublet L22. The lens L6 has negative power. The lens L6 has concave surfaces both at the enlargement and reduction sides. The lens L7 has positive power. The lens L7 has convex surfaces both at the enlargement and reduction sides. The cemented doublet L22 has negative power.

The lens L8 has positive power. The lens L8 has convex surfaces both at the enlargement and reduction sides. The lens L8 has aspherical surfaces at opposite sides.

The lenses L9 and L10 are bonded to each other into a cemented doublet L23. The lens L9 has negative power. The lens L9 has concave surfaces both at the enlargement and reduction sides. The lens L10 has positive power. The lens L10 has convex surfaces both at the enlargement and reduction sides. The lens L10 has an aspherical surface at the reduction side. The cemented doublet L23 has positive power.

The lens L11 (reduction-side lens) has positive power. The lens L11 has convex surfaces both at the enlargement and reduction sides.

The lens L2 is made of resin. The lenses L1 and L3 to L11 are made of glass.

In the projection system 3D, the portion at the reduction side of the lens L11 is a telecentric portion.

Data on the projection system 3D according to Example 4 are listed in a table below. In the table, FNo represents the f number of the projection system 3D, TTL represents the overall optical length, L represents the distance along the optical axis N from the enlargement-side surface of the lens L1 to the reduction-side surface of the lens L11, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L4, Fp2 represents the focal length of the lens L5, Fls represents the focal length of the lens L1, Flf represents the focal length of the lens L11, Fc represents the focal length of the cemented doublet L21, and LnθgF represents the partial dispersion ratio of the lens L1.

| Fno | 2.000 | |
|---|---|---|
| TTL | 95.386 | mm |
| L | 60.886 | mm |
| Bf | 34.500 | mm |
| ω | 43.808° | |
| YIM | 10.350 | mm |
| F | 10.834 | mm |
| Fp1 | 16.749 | mm |
| Fp2 | 21.297 | mm |
| FLS | −29.291 | mm |
| FLf | 30.967 | mm |
| Fc | 75.991 | mm |

| | |
|---|---|
| LnθgF | 0.640 |

Data on the lenses of the projection system 3D are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | D | nd | νd |
| S | 0 | inf | 730.000 | | |
| L01 | 1 | 27.29 | 2.000 | 1.9229 | 20.9 |
| | 2 | 13.16 | 3.726 | | |
| L02 | 3* | 48.27 | 2.180 | 1.5312 | 55.8 |
| | 4* | 9.46 | 4.620 | | |
| L03 | 5 | 89.56 | 1.200 | 1.6968 | 55.5 |
| L04 | 6 | 12.83 | 3.727 | 1.7400 | 28.3 |
| | 7 | −406.02 | 6.153 | | |
| L05 | 8 | 18.12 | 3.051 | 1.6727 | 32.1 |
| | 9 | −65.78 | 3.847 | | |
| 41 | 10 | inf | 3.437 | | |
| L06 | 11 | −15.64 | 1.000 | 1.9037 | 31.3 |
| L07 | 12 | 11.24 | 4.705 | 1.6889 | 31.1 |
| | 13 | −40.25 | 0.200 | | |
| L08 | 14* | 52.63 | 4.520 | 1.4971 | 81.6 |
| | 15* | −18.25 | 0.200 | | |
| L09 | 16 | inf | 1.000 | 1.9053 | 35.0 |
| L10 | 17 | 17.87 | 7.295 | 1.4971 | 81.6 |
| | 18* | −23.59 | 0.100 | | |
| L11 | 19 | 45.35 | 7.92 | 1.4970 | 81.55 |
| | 20 | −22.03 | 2.00 | | |
| 19 | 21 | inf | 29.00 | 1.52 | 64.20 |
| | 22 | inf | 3.50 | | |
| 18 | 23 | inf | 0.00 | | |

The aspherical coefficients are listed below.

| Surface number | 3 | 4 | |
|---|---|---|---|
| Conic constant | 0.00000E+00 | 0.00000E+00 | |
| Fourth-order | 9.71071E−05 | −6.05631E−05 | |
| coefficient | | | |
| Sixth-order | −1.13350E−06 | −2.62137E−06 | |
| coefficient | | | |
| Eighth-order | 1.96428E−09 | 1.59951E−09 | |
| coefficient | | | |
| Tenth-order | 6.27115E−11 | −1.16894E−10 | |
| coefficient | | | |
| Twelfth-order | −1.00139E−13 | 2.57421E−13 | |
| coefficient | | | |
| Fourteenth-order | −7.27281E−15 | 1.36887E−14 | |
| coefficient | | | |
| Sixteenth-order | 4.35727E−17 | −3.15852E−16 | |
| coefficient | | | |
| Surface number | 14 | 15 | 18 |
| Conic constant | −4.71065E+01 | 6.31187E−01 | −9.52163E−01 |
| Fourth-order | 1.50432E−05 | −7.39549E−07 | 7.64773E−06 |
| coefficient | | | |
| Sixth-order | 1.16400E−07 | 6.86351E−08 | 0.00000E+00 |
| coefficient | | | |
| Eighth-order | −3.05901E−09 | −1.38900E−09 | 0.00000E+00 |
| coefficient | | | |
| Tenth-order | 3.03824E−11 | −1.11280E−11 | 0.00000E+00 |
| coefficient | | | |
| Twelfth-order | −6.97470E−14 | 0.00000E+00 | 0.00000E+00 |
| coefficient | | | |

The projection system 3D according to the present example satisfies Conditional Expressions (1) and (2) below,

LnθgF≥0.6 (1)

ω>40° (2)

where LnθgF represents the partial dispersion ratio of the lens L1, and ω represents the maximum half angle of view of the overall projection system.

In the present example,
LnθgF 0.640
ω 43.808°
   are satisfied. Therefore, since LnθgF=0.640, Conditional Expression (1) is satisfied. Since ω=43.808°, Conditional Expression (2) is satisfied.

The projection system 3D according to the present example satisfies Conditional Expression (3) below,

1.0<Fp1/F<6.0 (3)

where F represents the focal length of the overall projection system, and Fp1 represents the focal length of the lens L4.

In the present example,
F 10.834 mm
Fp1 16.749 mm
   are satisfied. Fp1/F=1.546 is therefore achieved, so that Conditional Expression (3) is satisfied.

The projection system 3D according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L11, F represents the focal length of the overall projection system, BF represents the back focal length in air, Fls represents the focal length of the lens L1, and Flf represents the focal length of the lens L11.

In the present example,

| | | |
|---|---|---|
| L | 60.886 | mm |
| F | 10.834 | mm |
| Bf | 34.500 | mm |
| Fls | −29.291 | mm |
| Flf | 30.967 | mm |

are satisfied. Therefore, L/F=5.620 is achieved, so that Conditional Expression (4) is satisfied. BF/F=3.184 is achieved, so that Conditional Expression (5) is satisfied. Fls/F=−2.703 is achieved, so that Conditional Expression (6) is satisfied. Flf/F=2.858 is achieved, so that Conditional Expression (7) is satisfied.

The projection system 3D according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,
   |Δνd| 27.230
   |Δnd| 0.043
F 10.834 mm
Fc 75.991 mm
   are satisfied. Therefore, |Δνd|=27.230 is provided, so that Conditional Expression (8) is satisfied. |Δnd|=0.043 is provided, so that Conditional Expression (9) is satisfied. |Fc/F|=7.014 is achieved, so that Conditional Expression (10) is satisfied.

The projection system 3D according to the present example satisfies Conditional Expressions (11) and (12) below,

νdp2<40 (11)

1.5<Fp2/F<15.0 (12)

where F represents the focal length of the overall projection system, Fp2 represents the focal length of the lens L5, and νdp2 represents the Abbe number of the lens L5 at the d line.

In the present example,
νdp2 32.099
F 10.834 mm
Fp2 21.297 mm
   are satisfied. Therefore, νdp2=32.099 is provided, so that Conditional Expression (11) is satisfied. Fp2/F=1.966 is achieved, so that Conditional Expression (12) is satisfied.

### Effects and Advantages

The projection system 3D according to the present example, which satisfies Conditional Expressions (1) to (12), can provide the same effects and advantages as those provided by the projection system 3A according to Example 1.

In the projection system 3D according to the present example, the lens L1 has negative power. The maximum half angle of view of the projection system 3D is therefore readily increased. In the present example, the lens L11 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1 and L2 are each a negative lens having negative power. The lens L2 is an aspherical lens made of plastic. According to the configuration described above, image curvature produced by the projection system 3D can be suppressed.

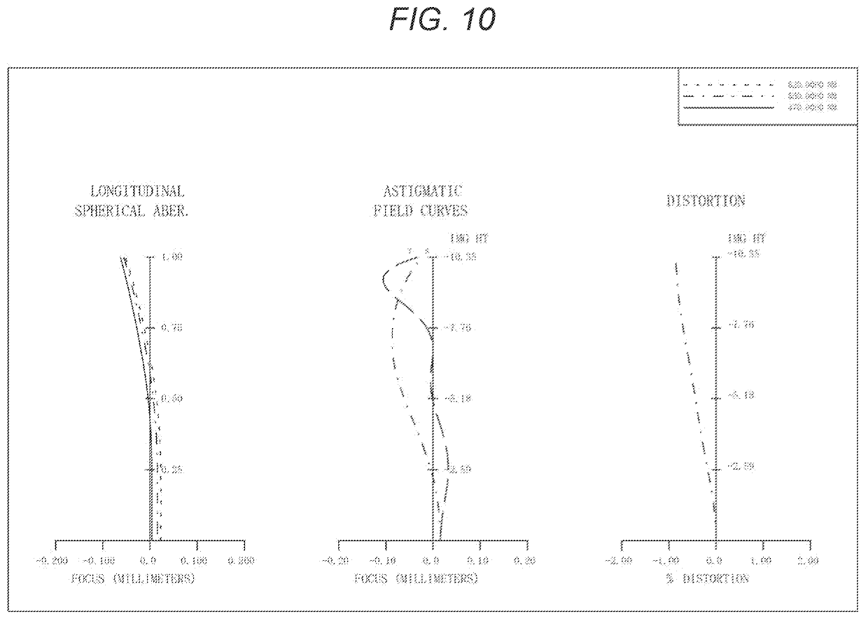

FIG. 10 shows the spherical aberration, astigmatism, and distortion produced by the projection system 3D. The projection system 3D according to the present example allows suppression of the aberrations that degrade an enlarged image, as shown in FIG. 10.

### Example 5

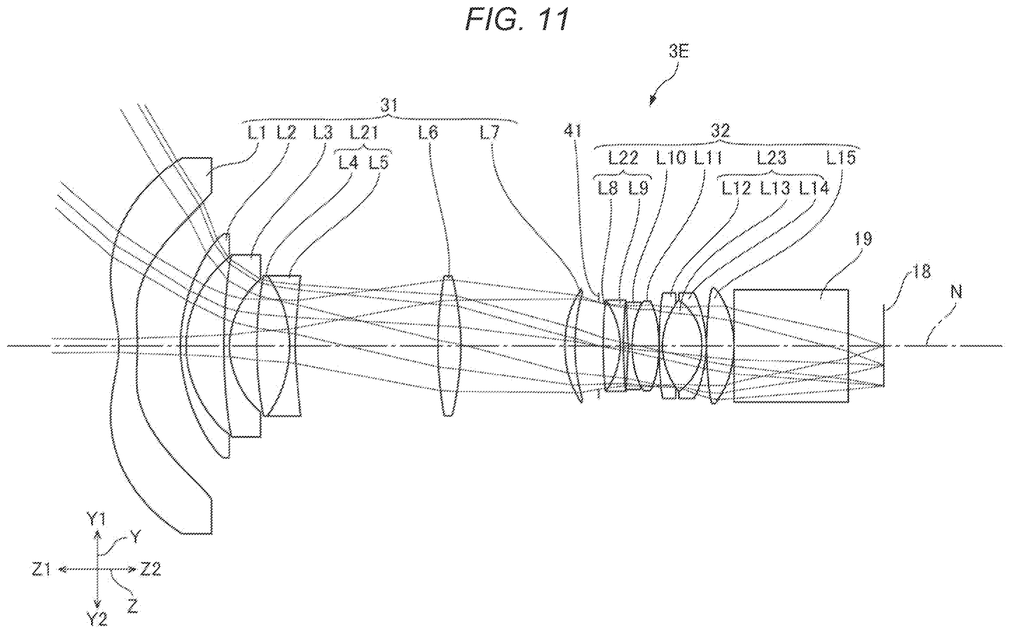

FIG. 11 is a beam diagram showing beams passing through a projection system 3E according to Example 5. The projection system 3E includes a first lens group 31 having positive power, an aperture stop 41, and a second lens group 32 having positive power sequentially arranged from the enlargement side toward the reduction side, as shown in FIG. 11. The aperture stop 41 is set to specify the brightness of the projection system 3E.

The first lens group 31 includes seven lenses L1 to L7. The lenses L1 to L7 are arranged in this order from the enlargement side toward the reduction side.

The lens L1 (first lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides. The lens L2 (second lens) has negative power. The lens L2 is a meniscus lens. The lens L2 has a convex surface at the enlargement side and a concave surface at the reduction side. The lens L3 has negative power. The lens L3 is a meniscus lens. The lens L3 has a convex surface at the enlargement side and a concave surface at the reduction side.

The lens L4 (third lens) and the lens L5 (fourth lens) are bonded to each other into a cemented doublet L21. The lens L4 has positive power. The lens L4 has convex surfaces both at the enlargement and reduction sides. The lens L4 is a first positive lens disposed at a position closest to the enlargement side out of a plurality of positive lenses in the first lens group 31. The lens L5 has negative power. The lens L5 has concave surfaces both at the enlargement and reduction sides. The cemented doublet L21 has positive power.

The lens L6 has positive power. The lens L6 has convex surfaces both at the enlargement and reduction sides. The lens L7 has positive power. The lens L7 is a meniscus lens. The lens L7 has a convex surface at the enlargement side and a concave surface at the reduction side. The lens L7 is a second positive lens disposed at a position closest to the reduction side out of the plurality of positive lenses in the first lens group 31.

The second lens group 32 includes eight lenses L8 to L15. The lenses L8 to L15 are arranged in this order from the enlargement side toward the reduction side.

The lenses L8 and L9 are bonded to each other into a cemented doublet L22. The lens L8 has positive power. The lens L8 has convex surfaces both at the enlargement and reduction sides. The lens L9 has negative power. The lens L9 has concave surfaces both at the enlargement and reduction sides. The cemented doublet L22 has negative power.

The lens L10 has negative power. The lens L10 has concave surfaces both at the enlargement and reduction sides. The lens L11 has positive power. The lens L11 has convex surfaces both at the enlargement and reduction sides. The lens L11 has aspherical surfaces at opposite sides.

The lenses L12, L13, and L14 are bonded to each other into a cemented triplet L23. The lens L12 has negative power. The lens L12 is a meniscus lens. The lens L12 has a convex surface at the enlargement side and a concave surface at the reduction side. The lens L13 has positive power. The lens L13 has convex surfaces both at the enlargement and reduction sides. The lens L14 has negative power. The lens L14 is a meniscus lens. The lens L14 has a concave surface at the enlargement side and a convex surface at the reduction side. The cemented triplet L23 has negative power.

The lens L15 (reduction-side lens) has positive power. The lens L15 has convex surfaces both at the enlargement and reduction sides.

The lens L1 is made of resin. The lenses L2 to L15 are made of glass.

In the projection system 3E, the portion at the reduction side of the lens L15 is a telecentric portion.

Data on the projection system 3E according to Example 5 are listed in a table below. In the table, FNo represents the f number of the projection system 3E, TTL represents the overall optical length, L represents the distance along the optical axis N from the enlargement-side surface of the lens L1 to the reduction-side surface of the lens L15, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L4, Fp2 represents the focal length of the lens L7, Fls represents the focal length of the lens L1, Flf represents the focal length of the lens L15, Fc represents the focal length of the cemented doublet L21, and LnθgF represents the partial dispersion ratio of the lens L2.

| Fno | 1.600 | |
|---|---|---|
| TTL | 205.940 | mm |
| L | 165.500 | mm |
| Bf | 40.440 | mm |
| ω | 59.493° | |
| YIM | 10.800 | mm |
| F | 6.346 | mm |
| Fp1 | 35.872 | mm |
| Fp2 | 76.125 | mm |
| FLs | −81.892 | mm |
| FLf | 40.563 | mm |
| Fc | −125.911 | mm |

| | |
|---|---|
| LnθgF | 0.600 |

Data on the lenses of the projection system 3E are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | D | nd | vd |
| S | 0 | inf | 937.000 | | |
| L01 | 1* | −21.01 | 5.000 | 1.5350 | 55.7 |
| | | −43.56 | 11.411 | | |
| L02 | 3 | 45.23 | 1.500 | 1.6889 | 31.1 |
| | 4 | 29.82 | 10.244 | | |
| L03 | 5 | 152.72 | 1.500 | 1.8919 | 37.1 |
| | 6 | 22.66 | 7.454 | | |
| L04 | 7 | 100.00 | 8.789 | 1.6989 | 30.1 |
| L05 | 8 | −32.55 | 1.500 | 1.8919 | 37.1 |
| | 9 | 93.23 | 38.610 | | |
| L06 | 10 | 99.63 | 5.987 | 1.6200 | 36.3 |
| | 11 | −79.96 | 27.927 | | |
| L07 | 12 | 27.78 | 2.727 | 1.8052 | 25.4 |
| | 13 | 48.24 | 6.626 | | |
| 41 | 14 | inf | 1.010 | | |
| L08 | 15 | 100.00 | 4.653 | 1.7283 | 28.5 |
| L09 | 16 | −22.57 | 1.000 | 1.8515 | 40.8 |
| | 17 | 86.53 | 1.047 | | |
| L10 | 18 | −356.44 | 1.000 | 1.8515 | 40.8 |
| | 19 | 26.36 | 0.20 | | |
| L11 | 20* | 23.43 | 7.03 | 1.5866 | 59.0 |
| | 21* | −37.52 | 0.15 | | |
| L12 | 22 | 126.36 | 1.00 | 1.8467 | 23.8 |
| L13 | 23 | 20.16 | 10.50 | 1.4970 | 81.5 |
| L14 | 24 | −15.34 | 1.00 | 1.7620 | 40.1 |
| | 25 | −34.92 | 0.15 | | |
| L15 | 26 | 84.09 | 7.49 | 1.4970 | 81.5 |
| | 27 | −25.82 | 0.10 | | |
| 19 | 28 | inf | 30.69 | 1.5168 | 64.2 |
| | 29 | inf | 9.65 | | |
| 18 | 30 | inf | 0.00 | | |

The aspherical coefficients are listed below.

| Surface number | 1 | 2 |
|---|---|---|
| Conic constant | −4.71645E+00 | 0.00000E+00 |
| Third-order | 6.65557E−04 | 6.41168E−04 |
| coefficient | | |
| Fourth-order | −6.64615E−06 | 3.21456E−05 |
| coefficient | −1.29136E−07 | −1.04498E−06 |
| Fifth-order | | |
| coefficient | | |
| Sixth-order | 1.74483E−10 | −1.07935E−09 |
| coefficient | | |
| Seventh-order | 2.41214E−11 | 1.02671E−10 |
| coefficient | | |
| Eighth-order | 1.42793E−12 | 2.45625E−12 |
| coefficient | | |
| Ninth-order | −8.05872E−16 | 5.00451E−14 |
| coefficient | | |
| Tenth-order | −2.23332E−16 | 4.84500E−16 |
| coefficient | | |
| Eleventh-order | −1.01616E−17 | −1.42142E−17 |
| coefficient | | |
| Twelfth-order | −1.25623E−19 | −5.50126E−19 |
| coefficient | 2.99183E−21 | −1.39287E−20 |
| Thirteenth-order | | |
| coefficient | | |
| Fourteenth-order | 7.92993E−23 | −2.16611E−22 |
| coefficient | | |
| Fifteenth-order | 3.88326E−25 | −1.02658E−24 |
| coefficient | | |
| Sixteenth-order | −7.30062E−27 | 8.71847E−26 |
| coefficient | | |
| Seventeenth-order | −2.21577E−28 | 4.40928E−27 |
| coefficient | | |
| Eighteenth-order | −4.84462E−30 | 1.03788E−28 |
| coefficient | | |
| Nineteenth-order | −2.00449E−32 | 7.02286E−31 |
| coefficient | | |
| Twentieth-order | 1.66034E−33 | −6.32984E−32 |
| coefficient | | |
| Surface number | 20 | 21 |
| Conic constant | −9.63780E−01 | −6.08522E−01 |
| Fourth-order | −1.10961E−05 | −6.21875E−06 |
| coefficient | | |
| Sixth-order | 1.62394E−08 | −4.51954E−09 |
| coefficient | | |
| Eighth-order | −5.86679E−11 | −1.89120E−10 |
| coefficient | | |
| Tenth-order | 3.73684E−13 | 5.81878E−13 |
| coefficient | | |

The projection system 3E according to the present example satisfies Conditional Expressions (1) and (2) below,

LnθgF≥0.6 (1)

ω>40° (2)

where LnθgF represents the partial dispersion ratio of the lens L2, and ω represents the maximum half angle of view of the overall projection system.

In the present example,
LnθgF 0.600
ω 59.493°
   are satisfied. Therefore, since LnθgF=0.600, Conditional Expression (1) is satisfied. Since ω=59.493°, Conditional Expression (2) is satisfied.

The projection system 3E according to the present example satisfies Conditional Expression (3) below,

1.0<Fp1/F<6.0 (3)

where F represents the focal length of the overall projection system, and Fp1 represents the focal length of the lens L4.

In the present example,
F 6.346 mm
Fp1 35.872 mm
   are satisfied. Fp1/F=5.653 is therefore achieved, so that Conditional Expression (3) is satisfied.

The projection system 3E according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L15, F represents the focal length of the overall projection system, BF represents the back focal length in air, Fls represents the focal length of the lens L1, and Flf represents the focal length of the lens L15.

In the present example,

| | | |
|---|---|---|
| L | 165.500 | mm |
| F | 6.346 | mm |
| Bf | 40.440 | mm |
| Fls | −81.892 | mm |
| Flf | 40.563 | mm |

are satisfied. Therefore, L/F=26.079 is achieved, so that Conditional Expression (4) is satisfied. BF/F=6.373 is achieved, so that Conditional Expression (5) is satisfied. Fls/F=−12.904 is achieved, so that Conditional Expression (6) is satisfied. Flf/F=6.392 is achieved, so that Conditional Expression (7) is satisfied.

The projection system 3E according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,
   |Δνd| 27.230
   |Δnd| 0.043
F 6.346 mm
Fc −125.911 mm are satisfied. Therefore, |Δνd|=27.230 is provided, so that Conditional Expression (8) is satisfied. |Δnd|=0.043 is provided, so that Conditional Expression (9) is satisfied. |Fc/F|=19.841 is achieved, so that Conditional Expression (10) is satisfied.

The projection system 3E according to the present example satisfies Conditional Expressions (11) and (12) below,

νdp2<40 (11)

1.5<Fp2/F<15.0 (12)

where F represents the focal length of the overall projection system, Fp2 represents the focal length of the lens L7, and νdp2 represents the Abbe number of the lens L7 at the d line.

In the present example,
νdp2 25.425
F 6.346 mm
Fp2 76.125 mm
   are satisfied. Therefore, νdp2=25.425 is provided, so that Conditional Expression (11) is satisfied. Fp2/F=11.996 is achieved, so that Conditional Expression (12) is satisfied.

### Effects and Advantages

The projection system 3E according to the present example, which satisfies Conditional Expressions (1) to (12), can provide the same effects and advantages as those provided by the projection system 3A according to Example 1.

In the projection system 3E according to the present example, the lens L1 has negative power. The maximum half angle of view of the projection system 3E is therefore readily increased. In the present example, the lens L15 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1, L2, and L3 are each a negative lens having negative power. The lens L1 is an aspherical lens made of plastic. According to the configuration described above, image curvature produced by the projection system 3E can be suppressed.

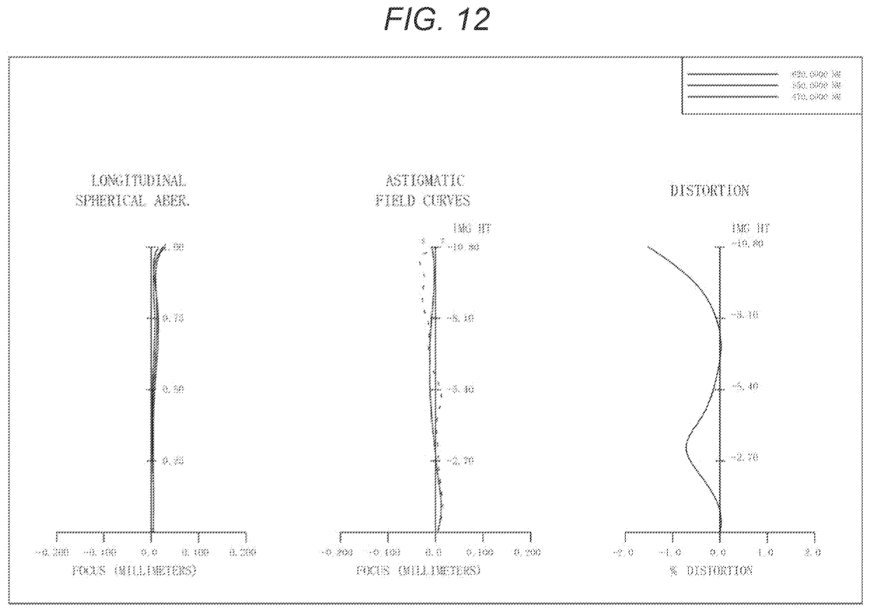

FIG. 12 shows the spherical aberration, astigmatism, and distortion produced by the projection system 3E. The projection system 3E according to the present example allows suppression of the aberrations that degrade an enlarged image, as shown in FIG. 12.

### Example 6

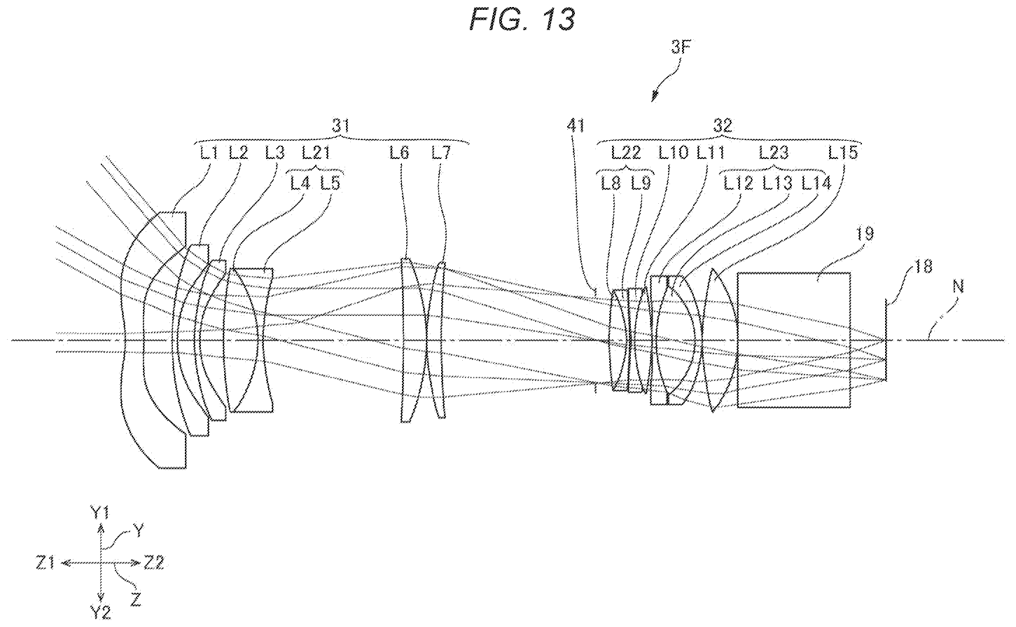

FIG. 13 is a beam diagram showing beams passing through a projection system 3F according to Example 6. The projection system 3F includes a first lens group 31 having positive power, an aperture stop 41, and a second lens group 32 having positive power sequentially arranged from the enlargement side toward the reduction side, as shown in FIG. 13. The aperture stop 41 is set to specify the brightness of the projection system 3F.

The first lens group 31 includes seven lenses L1 to L7. The lenses L1 to L7 are arranged in this order from the enlargement side toward the reduction side.

The lens L1 (first lens) has negative power. The enlargement-side surface of the lens L1 has a concave shape in the vicinity of the optical axis N and a convex shape at the periphery. The reduction-side surface of the lens L1 has a convex shape in the vicinity of the optical axis N and a concave shape at the periphery. The lens L1 has aspherical surfaces at opposite sides. The lens L2 (second lens) has negative power. The lens L2 is a meniscus lens. The lens L2 has a convex surface at the enlargement side and a concave surface at the reduction side. The lens L3 has negative power. The lens L3 is a meniscus lens. The lens L3 has a convex surface at the enlargement side and a concave surface at the reduction side.

The lens L4 (third lens) and the lens L5 (fourth lens) are bonded to each other into a cemented doublet L21. The lens L4 has positive power. The lens L4 has convex surfaces both at the enlargement and reduction sides. The lens L4 is a first positive lens disposed at a position closest to the enlargement side out of a plurality of positive lenses in the first lens group 31. The lens L5 has negative power. The lens L5 has concave surfaces both at the enlargement and reduction sides. The cemented doublet L21 has negative power.

The lens L6 has positive power. The lens L7 is a meniscus lens. The lens L7 has a concave surface at the enlargement side and a convex surface at the reduction side. The lens L7 has positive power. The lens L7 is a meniscus lens. The lens L7 has a convex surface at the enlargement side and a concave surface at the reduction side. The lens L7 is a second positive lens disposed at a position closest to the reduction side out of the plurality of positive lenses in the first lens group 31.

The second lens group 32 includes eight lenses L8 to L15. The lenses L8 to L15 are arranged in this order from the enlargement side toward the reduction side.

The lenses L8 and L9 are bonded to each other into a cemented doublet L22. The lens L8 has positive power. The lens L8 has convex surfaces both at the enlargement and reduction sides. The lens L9 has negative power. The lens L9 is a meniscus lens. The lens L9 has a concave surface at the enlargement side and a convex surface at the reduction side. The cemented doublet L22 has positive power.

The lens L10 has negative power. The lens L10 has concave surfaces both at the enlargement and reduction sides. The lens L11 has positive power. The lens L11 has convex surfaces both at the enlargement and reduction sides. The lens L11 has aspherical surfaces at opposite sides.

The lenses L12, L13, and L14 are bonded to each other into a cemented triplet L23. The lens L12 has negative power. The lens L12 has concave surfaces both at the enlargement and reduction sides. The lens L13 has positive power. The lens L13 has convex surfaces both at the enlargement and reduction sides. The lens L14 has negative power. The lens L14 is a meniscus lens. The lens L14 has a concave surface at the enlargement side and a convex surface at the reduction side. The cemented triplet L23 has negative power.

The lens L15 (reduction-side lens) has positive power. The lens L15 has convex surfaces both at the enlargement and reduction sides.

The lens L1 is made of resin. The lenses L2 to L15 are made of glass.

In the projection system 3F, the portion at the reduction side of the lens L15 is a telecentric portion.

Data on the projection system 3F according to Example 6 are listed in a table below. In the table, FNo represents the f number of the projection system 3F, TTL represents the overall optical length, L represents the distance along the optical axis N from the enlargement-side surface of the lens L1 to the reduction-side surface of the lens L15, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L4, Fp2 represents the focal length of the lens L7, Fls represents the focal length of the lens L1, Flf represents the focal length of the lens L15, Fc represents the focal length of the cemented doublet L21, and LnθgF represents the partial dispersion ratio of the lens L2.

| Fno | 1.600 | |
|---|---|---|
| TTL | 205.939 | mm |
| L | 165.500 | mm |
| Bf | 40.439 | mm |
| ω | 48.888° | |
| YIM | 10.800 | mm |
| F | 9.500 | mm |
| Fp1 | 39.897 | mm |
| Fp2 | 110.389 | mm |
| FLs | −84.342 | mm |
| FLf | 46.873 | mm |
| Fc | −61.149 | mm |

| | |
|---|---|
| LnθgF | 0.600 |

Data on the lenses of the projection system 3F are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | D | nd | vd |
| S | 0 | inf | 1377.452 | | |
| L01 | 1* | −22.38 | 5.000 | 1.5350 | 55.7 |
| | 2* | −47.71 | 7.559 | | |
| L02 | 3 | 67.69 | 1.500 | 1.6889 | 31.1 |
| | 4 | 29.54 | 4.716 | | |
| L03 | 5 | 53.05 | 1.500 | 1.7200 | 50.2 |
| | 6 | 27.32 | 6.281 | | |
| L04 | 7 | 100.00 | 9.259 | 1.6398 | 34.5 |
| L05 | 8 | −33.30 | 1.500 | 1.9053 | 35.0 |
| | 9 | 58.32 | 37.814 | | |
| L06 | 10 | −501.45 | 6.288 | 1.7432 | 49.3 |
| | 11 | −56.85 | 0.150 | | |
| L07 | 12 | 66.78 | 3.932 | 1.8340 | 37.2 |
| | 13 | 233.12 | 42.005 | | |
| 41 | 14 | inf | 3.482 | | |
| L08 | 15 | 100.00 | 4.276 | 1.7847 | 25.7 |
| L09 | 16 | −29.65 | 1.000 | 1.9037 | 31.3 |
| | 17 | −225.35 | 0.230 | | |
| L10 | 18 | −206.92 | 1.000 | 1.8919 | 37.1 |
| | 19 | 37.03 | 0.24 | | |
| L11 | 20* | 36.16 | 4.64 | 1.5866 | 59.0 |
| | 21* | −66.02 | 0.15 | | |
| L12 | 22 | −196.85 | 1.00 | 1.8467 | 23.8 |
| L13 | 23 | 36.13 | 10.50 | 1.4970 | 81.5 |
| L14 | 24 | −19.19 | 2.00 | 1.7620 | 40.1 |
| | 25 | −31.26 | 0.15 | | |
| L15 | 26 | 75.43 | 9.34 | 1.4970 | 81.5 |
| | 27 | −32.44 | 0.10 | | |
| 19 | 28 | inf | 30.69 | 1.5168 | 64.2 |
| | 29 | inf | 9.63 | | |
| 18 | 30 | inf | 0.02 | | |

The aspherical coefficients are listed below.

| Surface number | 1 | 2 |
|---|---|---|
| Conic constant | −6.44868E+00 | 0.00000E+00 |
| Third-order | 8.09542E−04 | 9.10066E−04 |
| coefficient | | |
| Fourth-order | −9.10159E−06 | 3.12624E−05 |
| coefficient | | |
| Fifth-order | −1.24980E−07 | −1.11299E−06 |
| coefficient | | |
| Sixth-order | 8.40864E−10 | 1.81722E−09 |
| coefficient | | |
| Seventh-order | 5.42185E−11 | 1.99122E−10 |
| coefficient | | |
| Eighth-order | 1.20199E−12 | 4.13320E−12 |
| coefficient | | |
| Ninth-order | 6.12108E−15 | 6.66801E−14 |
| coefficient | | |
| Tenth-order | −4.56167E−16 | 5.75696E−16 |
| coefficient | | |
| Eleventh-order | −1.33097E−17 | −3.60739E−17 |
| coefficient | | |
| Twelfth-order | −1.35866E−19 | −1.09628E−18 |
| coefficient | | |
| Thirteenth-order | 3.69804E−21 | 1.68673E−20 |
| coefficient | | |
| Fourteenth-order | 9.45226E−23 | 4.49845E−22 |
| coefficient | | |
| Fifteenth-order | 1.12020E−24 | 2.77068E−23 |
| coefficient | | |
| Sixteenth-order | 2.45273E−26 | 1.08860E−24 |
| coefficient | | |
| Seventeenth-order | 5.53309E−28 | 4.99319E−26 |
| coefficient | | |
| Eighteenth-order | 2.66224E−30 | −2.25879E−27 |
| coefficient | | |
| Nineteenth-order | −2.58776E−31 | −1.15869E−28 |
| coefficient | | |
| Twentieth-order | −1.24296E−32 | −5.99088E−30 |
| coefficient | | |
| Surface number | 20 | 21 |
| Conic constant | −4.15593E−02 | −9.02789E+00 |
| Fourth-order | −6.13035E−06 | 9.63843E−07 |
| coefficient | | |
| Sixth-order | 2.96660E−09 | 1.91189E−08 |
| coefficient | | |
| Eighth-order | −5.77471E−11 | −1.60770E−10 |
| coefficient | | |
| Tenth-order | 3.42196E−13 | 6.83047E−13 |
| coefficient | | |

The projection system 3F according to the present example satisfies Conditional Expressions (1) and (2) below,

LnθgF≥0.6 (1)

ω>40° (2)

where LnθgF represents the partial dispersion ratio of the lens L2, and ω represents the maximum half angle of view of the overall projection system.

In the present example,
LnθgF 0.600
ω 48.888°
   are satisfied. Therefore, since LnθgF=0.600, Conditional Expression (1) is satisfied. Since ω=48.888°, Conditional Expression (2) is satisfied.

The projection system 3F according to the present example satisfies Conditional Expression (3) below,

1.0<Fp1/F<6.0 (3)

where F represents the focal length of the overall projection system, and Fp1 represents the focal length of the lens L4.

In the present example,
F 9.500 mm
Fp1 39.897 mm
   are satisfied. Fp1/F=4.200 is therefore achieved, so that Conditional Expression (3) is satisfied.

The projection system 3F according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L15, F represents the focal length of the overall projection system, BF represents the back focal length in air, Fls represents the focal length of the lens L1, and Flf represents the focal length of the lens L15.

In the present example,

| | | |
|---|---|---|
| L | 165.500 | mm |
| F | 9.500 | mm |
| Bf | 40.439 | mm |
| Fls | −84.342 | mm |
| Flf | 46.873 | mm |

are satisfied. Therefore, L/F=17.421 is achieved, so that Conditional Expression (4) is satisfied. BF/F=4.257 is achieved, so that Conditional Expression (5) is satisfied. Fls/F=−8.878 is achieved, so that Conditional Expression (6) is satisfied. Flf/F=4.934 is achieved, so that Conditional Expression (7) is satisfied.

The projection system 3F according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,
   |Δνd| 0.570
   |Δnd| 0.265
F 9.500 mm
Fc −61.149 mm
   are satisfied. Therefore, |Δνd|=0.570 is provided, so that Conditional Expression (8) is satisfied. |Δnd|=0.265 is provided, so that Conditional Expression (9) is satisfied. |Fc/F|=6.437 is achieved, so that Conditional Expression (10) is satisfied.

The projection system 3F according to the present example satisfies Conditional Expressions (11) and (12) below,

νdp2<40 (11)

1.5<Fp2/F<15.0 (12)

where F represents the focal length of the overall projection system, Fp2 represents the focal length of the lens L7, and νdp2 represents the Abbe number of the lens L7 at the d line.

In the present example,
νdp2 37.161
F 9.500 mm
Fp2 110.389 mm
   are satisfied. Therefore, νdp2=37.161 is provided, so that Conditional Expression (11) is satisfied. Fp2/F=11.620 is achieved, so that Conditional Expression (12) is satisfied.

### Effects and Advantages

The projection system 3F according to the present example, which satisfies Conditional Expressions (1) to (12), can provide the same effects and advantages as those provided by the projection system 3A according to Example 1.

In the projection system 3F according to the present example, the lens L1 has negative power. The maximum half angle of view of the projection system 3F is therefore readily increased. In the present example, the lens L15 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1, L2, and L3 are each a negative lens having negative power. The lens L1 is an aspherical lens made of plastic. According to the configuration described above, image curvature produced by the projection system 3F can be suppressed.

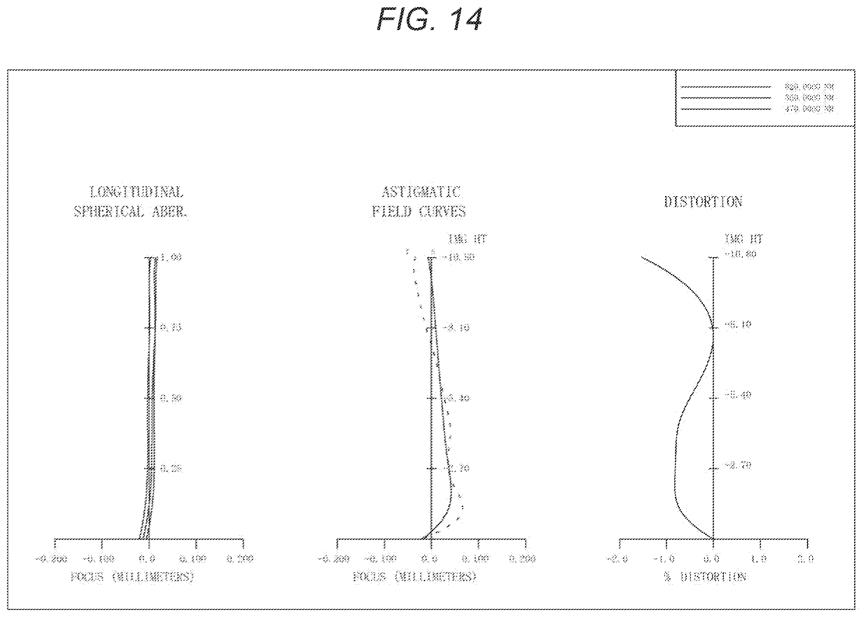

FIG. 14 shows the spherical aberration, astigmatism, and distortion produced by the projection system 3F. The projection system 3F according to the present example allows suppression of the aberrations that degrade an enlarged image, as shown in FIG. 14.

### Example 7

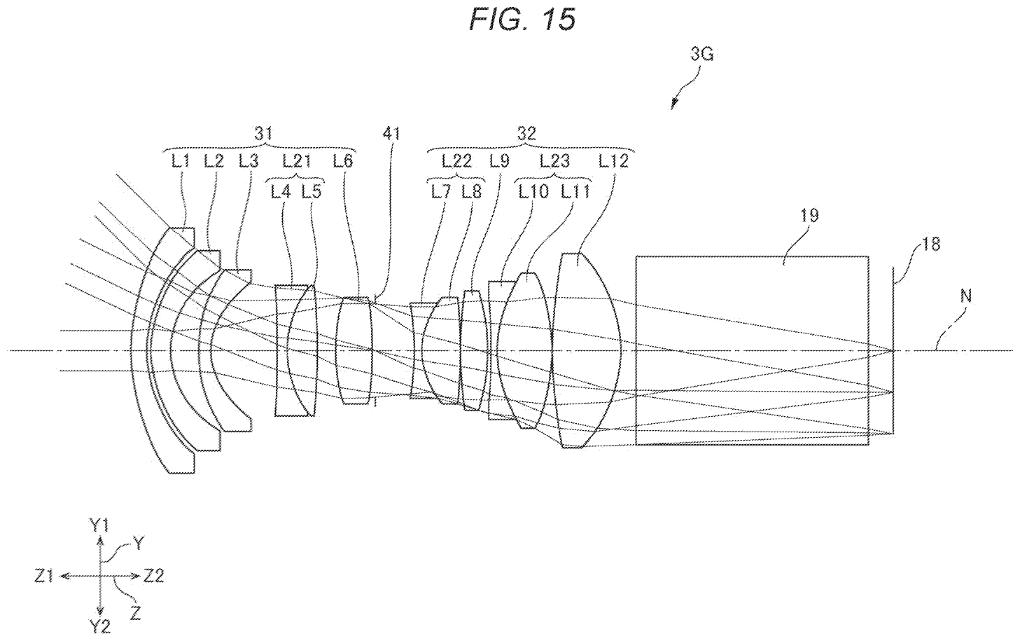

FIG. 15 is a beam diagram showing beams passing through a projection system 3G according to Example 7. The projection system 3G includes a first lens group 31 having positive power, an aperture stop 41, and a second lens group 32 having positive power sequentially arranged from the enlargement side toward the reduction side, as shown in FIG. 15. The aperture stop 41 is set to specify the brightness of the projection system 3G.

The first lens group 31 includes six lenses L1 to L6. The lenses L1 to L6 are arranged in this order from the enlargement side toward the reduction side.

The lens L1 (first lens) has negative power. The lens L1 is a meniscus lens. The lens L1 has a convex surface at the enlargement side and a concave surface at the reduction side. The lens L2 (second lens) has negative power. The lens L2 is a meniscus lens. The lens L2 has a convex surface at the enlargement side and a concave surface at the reduction side. The lens L3 has negative power. The lens L3 is a meniscus lens. The lens L3 has a convex surface at the enlargement side and a concave surface at the reduction side. The lens L3 has aspherical surfaces at opposite sides.

The lens L4 (third lens) and the lens L5 (fourth lens) are bonded to each other into a cemented doublet L21. The lens L4 has negative power. The lens L4 has concave surfaces both at the enlargement and reduction sides. The lens L5 has positive power. The lens L5 has convex surfaces both at the enlargement and reduction sides. The lens L5 is a first positive lens disposed at a position closest to the enlargement side out of a plurality of positive lenses in the first lens group 31. The cemented doublet L21 has positive power.

The lens L6 has positive power. The lens L6 has convex surfaces both at the enlargement and reduction sides. The lens L6 is a second positive lens disposed at a position closest to the reduction side out of the plurality of positive lenses in the first lens group 31.

The second lens group 32 includes six lenses L7 to L12. The lenses L7 to L12 are arranged in this order from the enlargement side toward the reduction side.

The lenses L7 and L8 are bonded to each other into a cemented doublet L22. The lens L7 has negative power. The lens L7 has concave surfaces both at the enlargement and reduction sides. The lens L8 has positive power. The lens L8 has convex surfaces both at the enlargement and reduction sides. The cemented doublet L22 has negative power.

The lens L9 has positive power. The lens L9 has convex surfaces both at the enlargement and reduction sides. The lens L9 has aspherical surfaces at opposite sides.

The lenses L10 and L11 are bonded to each other into a cemented doublet L23. The lens L10 has negative power. The lens L10 has concave surfaces both at the enlargement and reduction sides. The lens L11 has positive power. The lens L11 has convex surfaces both at the enlargement and reduction sides. The lens L11 has an aspherical surface at the reduction side. The cemented doublet L23 has positive power.

The lens L12 (reduction-side lens) has positive power. The lens L12 has convex surfaces both at the enlargement and reduction sides.

The lens L3 is made of resin. The lenses L1, L2, L4 to L12 are made of glass.

In the projection system 3G, the portion at the reduction side of the lens L12 is a telecentric portion.

Data on the projection system 3G according to Example 7 are listed in a table below. In the table, FNo represents the f number of the projection system 3G, TTL represents the overall optical length, L represents the distance along the optical axis N from the enlargement-side surface of the lens L1 to the reduction-side surface of the lens L12, BF represents the back focal length, ω represents the maximum half angle of view of the overall projection system, YIM represents the distance from the optical axis N to the largest image height of a projection image formed at the liquid crystal panel 18, F represents the focal length of the overall projection system, Fp1 represents the focal length of the lens L5, Fp2 represents the focal length of the lens L6, Fls represents the focal length of the lens L1, Flf represents the focal length of the lens L12, Fc represents the focal length of the cemented doublet L21, and LnθgF represents the partial dispersion ratio of the lens L1.

| Fno | 2.000 | |
|---|---|---|
| TTL | 95.250 | mm |
| L | 61.243 | mm |
| Bf | 34.007 | mm |
| ω | 44.287° | |
| YIM | 10.350 | mm |
| F | 10.840 | mm |
| Fp1 | 14.890 | mm |
| Fp2 | 20.332 | mm |
| FLs | −69.313 | mm |
| FLf | 28.771 | mm |
| Fc | 544.196 | mm |

| | |
|---|---|
| LnθgF | 0.640 |

Data on the lenses of the projection system 3G are listed below. The surfaces of the lenses are numbered sequentially from the enlargement side to the reduction side. Reference characters are given to the screen, the lenses, the aperture stop, the dichroic prism, and the liquid crystal panels. An aspheric surface has a surface number followed by *. Reference character R represents the radius of curvature. Reference character D represents the axial inter-surface spacing. Reference character nd represents the refractive index at the d line. Reference character νd represents the Abbe number at the d line. Reference characters R and D are expressed in millimeters.

| Reference | Surface | | | | |
|---|---|---|---|---|---|
| character | number | R | D | nd | vd |
| S | 0 | inf | 730.000 | | |
| L01 | 1 | 26.76 | 2.000 | 1.7200 | 50.2 |
| | 2 | 16.90 | 0.500 | | |
| L02 | 3 | 16.18 | 2.560 | 1.9229 | 20.9 |
| | 4 | 11.26 | 3.443 | | |
| L03 | 5* | 29.81 | 1.485 | 1.5311 | 55.8 |
| | 6* | 9.32 | 8.158 | | |
| L04 | 7 | −97.97 | 1.200 | 1.7432 | 49.3 |
| L05 | 8 | 12.62 | 3.824 | 1.7380 | 32.3 |
| | 9 | −77.98 | 2.377 | | |
| L06 | 10 | 24.72 | 4.604 | 1.7495 | 35.3 |
| | 11 | −37.13 | 0.353 | | |
| 41 | 12 | inf | 4.829 | | |
| L07 | 13 | −27.27 | 1.000 | 1.9037 | 31.3 |
| L08 | 14 | 10.17 | 4.705 | 1.7174 | 29.5 |
| | 15 | −84.37 | 0.200 | | |
| L09 | 16* | 97.31 | 3.276 | 1.4971 | 81.6 |
| | 17* | −24.20 | 0.252 | | |
| L10 | 18 | −605.93 | 1.000 | 1.9037 | 31.3 |
| L11 | 19 | 17.00 | 6.95 | 1.4971 | 81.6 |
| | 20* | −20.92 | 0.10 | | |
| L12 | 21 | 63.12 | 8.42 | 1.4970 | 81.5 |
| | 22 | −17.73 | 2.00 | | |
| 19 | 23 | inf | 29.00 | 1.5168 | 64.2 |
| | 24 | inf | 3.05 | | |
| 18 | 25 | inf | −0.05 | | |

The aspherical coefficients are listed below.

| Surface number | 5 | 6 | |
|---|---|---|---|
| Conic constant | 0.00000E+00 | 0.00000E+00 | |
| Fourth-order | 5.21138E−04 | 4.63111E−04 | |
| coefficient | | | |
| Sixth-order | −1.29437E−05 | −1.28648E−05 | |
| coefficient | | | |
| Eighth-order | 2.58504E−07 | 9.15696E−08 | |
| coefficient | | | |
| Tenth-order | −3.50568E−09 | 3.38893E−09 | |
| coefficient | | | |
| Twelfth-order | 2.92074E−11 | −1.28693E−10 | |
| coefficient | | | |
| Fourteenth-order | −1.35386E−13 | 1.60120E−12 | |
| coefficient | | | |
| Fourteenth-order | 2.70073E−16 | −7.37400E−15 | |
| coefficient | | | |
| Surface number | 16 | 17 | 20 |
| Conic constant | 0.00000E+00 | 4.52794E−01 | −8.48495E−01 |
| Fourth-order | 8.24555E−06 | 1.74792E−05 | 1.17936E−05 |
| coefficient | | | |
| Sixth-order | 9.96569E−07 | 1.68481E−07 | 5.92260E−08 |
| coefficient | | | |
| Eighth-order | −1.74064E−08 | −1.33057E−09 | |
| coefficient | | | |
| Tenth-order | 1.94591E−10 | −1.68575E−11 | |
| coefficient | | | |
| Twelfth-order | −7.96518E−13 | | |
| coefficient | | | |

The projection system 3G according to the present example satisfies Conditional Expressions (1) and (2) below,

LnθgF≥0.6 (1)

ω>40° (2)

where LnθgF represents the partial dispersion ratio of the lens L1, and ω represents the maximum half angle of view of the overall projection system.

In the present example,
LnθgF 0.640
ω 44.287°
   are satisfied. Therefore, since LnθgF=0.640, Conditional Expression (1) is satisfied. Since ω=44.287°, Conditional Expression (2) is satisfied.

The projection system 3G according to the present example satisfies Conditional Expression (3) below,

1.0<Fp1/F<6.0 (3)

where F represents the focal length of the overall projection system, and Fp1 represents the focal length of the lens L5.

In the present example,
F 10.840 mm
Fp1 14.890 mm
   are satisfied. Fp1/F=1.374 is therefore achieved, so that Conditional Expression (3) is satisfied.

The projection system 3G according to the present example satisfies all Conditional Expressions (4), (5), (6), and (7) below,

5.0<L/F<30.0 (4)

BF/F>2.0 (5)

−20.0<Fls/F<−2.5 (6)

2.5<Flf/F<10.0 (7)

where L represents the distance from the enlargement-side lens surface of the lens L1 to the reduction-side lens surface of the lens L12, F represents the focal length of the overall projection system, BF represents the back focal length in air, Fls represents the focal length of the lens L1, and Flf represents the focal length of the lens L12.

In the present example,

| | | |
|---|---|---|
| L | 61.243 | mm |
| F | 10.840 | mm |
| Bf | 34.007 | mm |
| Fls | −69.313 | mm |
| Flf | 28.771 | mm |

are satisfied. Therefore, L/F=5.650 is achieved, so that Conditional Expression (4) is satisfied. BF/F=3.137 is achieved, so that Conditional Expression (5) is satisfied. Fls/F=−6.394 is achieved, so that Conditional Expression (6) is satisfied. Flf/F=2.654 is achieved, so that Conditional Expression (7) is satisfied.

The projection system 3G according to the present example satisfies all Conditional Expressions (8), (9), and (10) below,

0.5<|Δνd|<30.0 (8)

|Δnd|<0.35 (9)

4.0<|Fc/F|<55.0 (10)

where F represents the focal length of the overall projection system, Δνd represents the difference in Abbe number at the d line between the lenses L3 and L4, And represents the difference in refractive index at the d line between the lenses L3 and L4, and Fc represents the focal length of the cemented doublet L21.

In the present example,
   |Δνd| 17.078
   |Δnd| 0.005
F 10.840 mm
Fc 544.196 mm
   are satisfied. Therefore, |Δνd|=17.078 is provided, so that Conditional Expression (8) is satisfied. |Δnd|=0.005 is provided, so that Conditional Expression (9) is satisfied. |Fc/F|=50.204 is achieved, so that Conditional Expression (10) is satisfied.

The projection system 3G according to the present example satisfies Conditional Expressions (11) and (12) below,

νdp2<40 (11)

1.5<Fp2/F<15.0 (12)

where F represents the focal length of the overall projection system, Fp2 represents the focal length of the lens L6, and νdp2 represents the Abbe number of the lens L7 at the d line.

In the present example,
νdp2 35.283
F 10.840 mm
Fp2 20.332 mm
   are satisfied. Therefore, νdp2=35.283 is provided, so that Conditional Expression (11) is satisfied. Fp2/F=1.876 is achieved, so that Conditional Expression (12) is satisfied.

### Effects and Advantages

The projection system 3G according to the present example, which satisfies Conditional Expressions (1) to (12), can provide the same effects and advantages as those provided by the projection system 3A according to Example 1.

In the projection system 3G according to the present example, the lens L1 has negative power. The maximum half angle of view of the projection system 3G is therefore readily increased. In the present example, the lens L12 has positive power. The portion at the reduction side of the second lens group 32 therefore readily serves as a telecentric portion.

In the present example, the first lens group 31 includes a plurality of negative lenses disposed in succession from a position closest to the enlargement side toward the reduction side. In the present example, the lenses L1, L2, and L3 are each a negative lens having negative power. The lens L3 is an aspherical lens made of plastic. According to the configuration described above, image curvature produced by the projection system 3G can be suppressed.

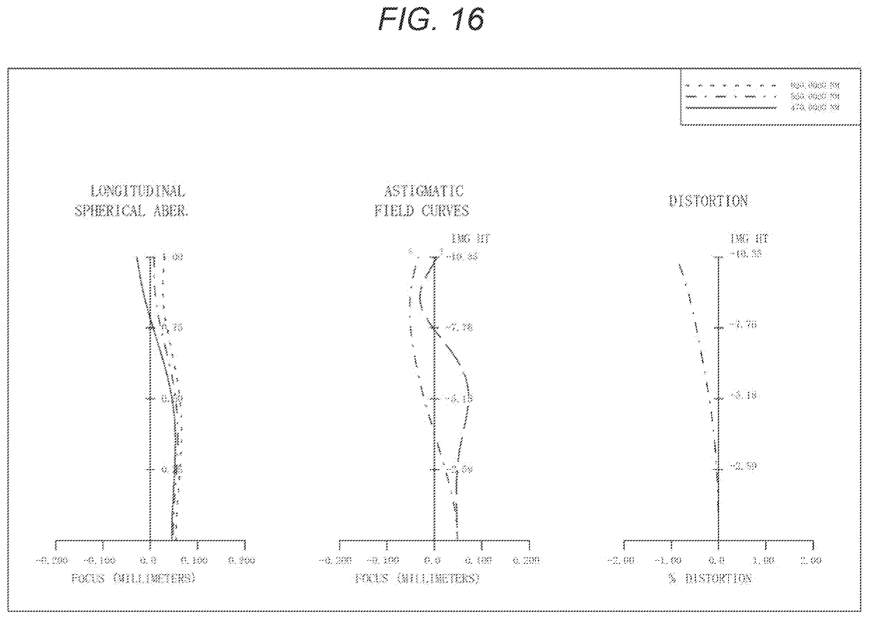

FIG. 16 shows the spherical aberration, astigmatism, and distortion produced by the projection system 3G. The projection system 3G according to the present example allows suppression of the aberrations that degrade an enlarged image, as shown in FIG. 16.

### OTHER EXAMPLES

In the examples described above, focusing can be performed by moving one or more of the lenses in the first lens group 31 along the optical axis N. In this case, it is desirable to move a cemented doublet or triplet or a positive lens contained in the first lens group 31 along the optical axis N.

A preferable embodiment of the present disclosure has been described above. The present disclosure is, however, not limited to the specific embodiment described above, and a variety of modifications and changes can be made to the embodiment within the intent of the present disclosure described in the claims as long as no particular limitation is set in the above description. As an example, in the embodiment of the present disclosure, the liquid crystal panel 18 is used as the image formation devices, but the liquid crystal panel 18 is not necessarily used and may be replaced, for example, with reflective liquid crystal panels or digital micromirror devices (DMDs).

What is claimed is:

1. A projection system comprising
a first lens group having refractive power, an aperture stop, and a second lens group having refractive power sequentially arranged from an enlargement side toward a reduction side,
wherein the first lens group includes a first lens disposed at a position closest to the enlargement side, a second lens disposed at the reduction side of the first lens, and a plurality of positive lenses disposed at the reduction side of the second lens and each having positive power,
a portion at the reduction side of a reduction-side lens that forms the second lens group and is located at a position closest to the reduction side is a telecentric portion, and
the projection system satisfies Conditional Expressions (1) and (2) below,
LnθgF≥0.6 (1)
ω>40° (2)
where LnθgF represents a partial dispersion ratio of one of the first and second lenses, and ω represents a maximum half angle of view of the overall projection system.

2. The projection system according to claim 1, wherein the projection system satisfies Conditional Expression (3) below,
1.0<Fp1/F<6.0 (3)
where F represents a focal length of the overall projection system, and Fp1 represents a focal length of a first positive lens disposed at a position closest to the enlargement side out of the plurality of positive lenses.

3. The projection system according to claim 1,
wherein the first lens has negative power, and
the reduction-side lens has positive power.

4. The projection system according to claim 1,
wherein the first lens group includes a plurality of negative lenses arranged in succession from a position closest to the enlargement side toward the reduction side, and
one of the plurality of the negative lenses is an aspherical lens made of plastic.

5. The projection system according to claim 1, wherein the projection system satisfies all Conditional Expressions (4), (5), (6), and (7) below,
5.0<L/F<30.0 (4)
BF/F>2.0 (5)
−20.0<Fls/F<−2.5 (6)
2.5<Flf/F<10.0 (7)
where L represents a distance from an enlargement-side lens surface of the first lens to a reduction-side lens surface of the reduction-side lens, F represents a focal length of the overall projection system, BF represents a back focal length in air, Fls represents a focal length of the first lens, and Flf represents a focal length of the reduction-side lens.

6. The projection system according to claim 1,
wherein the first lens group includes a cemented doublet into which a third lens and a fourth lens are bonded to each other, and
the projection system satisfies all Conditional Expressions (8), (9), and (10) below,
0.5<|Δνd|<30.0 (8)

|Δnd|<0.35 (9)
4.0<|Fc/F|<55.0 (10)
where F represents a focal length of the overall projection system, Δνd represents a difference in an Abbe number at a d line between the third lens and the fourth lens, And represents a difference in a refractive index at the d line between the third lens and the fourth lens, and Fc represents a focal length of the cemented doublet.

7. The projection system according to claim 1,
wherein the projection system satisfies Conditional Expressions (11) and (12) below,
νdp2<40 (11)
1.5<Fp2/F<15.0 (12)
where F represents a focal length of the overall lens system, Fp2 represents a focal length of a second positive lens disposed at a position closest to the reduction side out of the plurality of positive lenses, and νdp2 represents an Abbe number of the second positive lens at a d line.

8. A projector comprising:
the projection system according to claim 1; and
an image formation device that forms a projection image in a reduction-side conjugate plane of the projection system.
